(19) United States
(12) Patent Application Publication
(10) Pub. No.: US 2026/0300370 A1
(43) Pub. Date: Oct. 1, 2026

(54) Resource Conserving GraphRAG

(71) Applicant: Microsoft Technology Licensing, LLC, Redmond, WA (US)

(72) Inventors: Darren Keith EDGE, Cambridge (GB); Jonathan Karl LARSON, Bremerton, WA (US); Thu Ha TRINH, Kirkland, WA (US)

(73) Assignee: Microsoft Technology Licensing, LLC, Redmond, WA (US)

(21) Appl. No.: 19/096,188

(22) Filed: Mar. 31, 2025

(51) Int. Cl. G06F 16/36; G06F 40/289

(52) U.S. Cl. CPC G06F 16/367; G06F 40/289

(57) ABSTRACT

This document relates to providing meaningful information relating to a dataset. One example can chunk source documents into overlapping text chunks having a first size and extract concepts in the text chunks. The example can create a co-occurrence graph of the concepts and refine the co-occurrence graph by changing to a second chunk size.

### BACKGROUND

Retrieval augmented generation (RAG) techniques are the cornerstone of grounding LLMs to domain-specific data by performing similarity searches over embeddings stored in vector databases.

### SUMMARY

This patent relates to providing meaningful information relating to a dataset. One example can chunk source documents into overlapping text chunks having a first size and extract concepts in the text chunks. The example can create a co-occurrence graph of the concepts and refine the co-occurrence graph by changing to a second chunk size.

Another example can receive a user query relating to private documents that are not known to a generative model and embed the user query to generate query embeddings. The example can compare the query embeddings against embeddings of chunks of the private documents to generate ranked chunks and obtain a comparison of the ranked chunks to community chunks relating to the private documents to produce ranked communities to the user query.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1 and 2 illustrate example pipelines that are consistent with some implementations of the present concepts.

FIGS. 3-26 illustrate example screenshots that are consistent with some implementations of the present concepts.

FIG. 27 illustrates an example system that is consistent with some implementations of the present concepts.

FIG. 28 relates to an example generative language model that is consistent with some implementations of the present concepts.

FIGS. 29-32 illustrate example flowcharts that are consistent with some implementations of the present concepts.

### DETAILED DESCRIPTION

The present concepts relate to leveraging generative artificial intelligence models (hereinafter, “generative models’) to provide useful information relating to a dataset. As used herein, the dataset can be previously unseen by the generative models during training. For example, the dataset can be a private or internally available dataset. Example generative models include large language models (LLM), small language models (SLM), and/or foundation/transformer models, among others.

Generative models allow computing resources to provide functionalities that were previously unavailable. For instance, the generative models can receive a question (e.g., query or prompt) from a user and provide detailed answers that are more accurate than existing technologies. However, the generative models consume large amounts of computing resources for their training and deployment. The current concepts allow computing resources to be utilized more efficiently by selectively employing generative models to answer user queries (e.g., prompts). Thus, at the front end, the user experiences as good or better experiences (e.g., answers) while the back end processing, including the generative model, use less computing resources (e.g., fewer processing cycles and/or lower memory use) than existing techniques.

Retrieval augmented generation (RAG) techniques are the cornerstone of grounding generative models, such as LLMs to private datasets (e.g., domain-specific data). RAG performs similarity search over embeddings stored in vector databases. Vector-based approaches to RAG have become the de facto standard for AI-powered question answering over private datasets, excelling at “local” queries requiring retrieval of text that resembles the query. Graph-based RAG approaches, meanwhile, including the Microsoft GraphRAG library, have recently been shown to outperform VectorRAG on a variety of tasks, including “global” queries requiring thematic understanding of the entire dataset. However, the up-front costs of using a language model to create and summarize a graph-based data index, combined with the recurring costs of using all parts of this index to answer every global query, can be prohibitive for many use cases. These technical problems are addressed by the present concepts, some of which are referred to herein as ‘LazyGraphRAG’—a hybrid RAG approach that blends the best-first and breadth-first search characteristics of VectorRAG and graphRAG respectively.

LazyGraphRAG can be termed ‘lazy’ because it only employs a concept cooccurrence graph, rather than a curated knowledge graph, and defers language model use until query time. This concept graph is then used in multiple ways to provide the breadth of dataset coverage missing from VectorRAG, supporting graph-based query expansion, relevant chunk search, and answer generation. When LazyGraphRAG is calibrated to the resource cost of VectorRAG, LazyGraphRAG significantly outperforms all competing methods across the local-global query spectrum. Furthermore, increasing a resource budget parameter can smoothly increase LazyGraphRAG answer quality for all query types, surpassing GraphRAG Global Search as well as all other against competing methods.

LazyGraphRAG provides a technical solution to the high resource usage technical problem by deferring LLM use until query time while still using a graph-based index to model the topical structure of the private data as a whole. While GraphRAG uses an LLM-intensive process to construct a curated entity relationship graph with rich descriptions for both nodes and edges, simpler methods of graph construction, such as noun-phrase co-occurrence can yield comparable structures at effectively zero resource cost. Similarly, summarizing source text chunks directly at query time, rather than summarizing pre-generated summaries of entities and relationships, can retain more relevant detail for analysis while eliminating LLM-based indexing costs. In the absence of a summary-based data index, a lazy approach to graphRAG also uses a lazy search process to retrieve relevant text chunks at query time, which could then be summarized just-in-time using a similar query-focused summarization as GraphRAG Global Search.

The present concepts include lazy graph-based indexing, lazy graph-based query expansion, lazy graph-based retrieval, and lazy graph-based generation. Lazy graph-based indexing extracts a noun-phrase co-occurrence graph from text chunks using natural language processing (NLP). LazyGraphRAG partitions the noun-phrase co-occurrence graph partitions into a hierarchical community structure. This processing incurs no LLM text completion costs and identical text embedding costs to VectorRAG.

Lazy graph-based query expansion can optionally expand the input query in ways that add detail and diversity. An initial LLM call is used to decompose the input query into candidate sub-queries based on the LLM's general understanding. Input query-chunk similarity, chunk-concept relationships, and chunk-concept-community relationships are then used to create relevant context for a second LLM call that generates a pseudo-answer to the input query. This answer is then used as context for a third call in which the LLM uses this data context to review and improve each sub-query and augment it with a list of related concepts drawn from the concept graph. Each sub-query and its related concepts are then converted to vectors using text embedding, with the weighted average of these vectors used to rank text chunks in the retrieval stage.

Lazy graph-based retrieval generalizes the “best-first” search of Vector-RAG, which ranks text chunks based on their vector similarity to the input query. Lazy graph-based retrieval accomplishes the retrieval by using query-chunk similarity and chunk-concept-community relationships to create a best-first ranking of communities from which to mine relevant text chunks in “breadth first” style. LLM relevance judgments are used to guide a lazy traversal of the hierarchical community structure, terminating either when there are no more communities yielding relevant chunks, or whenever a user-defined relevance test budget has been reached. This budget scales both quality and cost in a predictable way.

Lazy graph-based generation involves reconstructing focused noun-phrase co-occurrence graphs from relevant text chunks. Lazy graph-based generation uses the emerging communities of related text chunks for parallel LLM extraction of query-relevant claims. Only a single (e.g., a final) LLM call then reduces the most relevant claims from across the dataset into a final narrative answer.

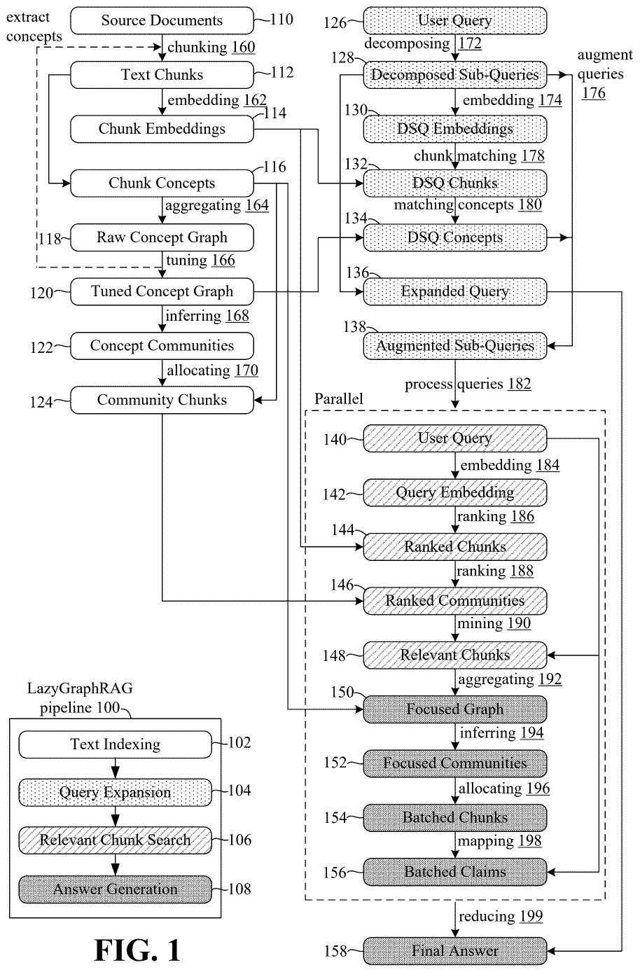

FIG. 1 shows an example LazyGraphRAG pipeline 100 that is configured to implement some of the present concepts. The LazyGraphRAG pipeline 100 includes four broad stages entailing data indexing stage 102, query expansion stage 104, relevant chunk search stage 106, and answer generation stage 108. Data indexing stage 102 entails blocks 110-124. Query expansion stage 104 entails blocks 126-138. Relevant chunk search stage 106 entails blocks 140-148. Answer generation stage 108 entails blocks 150-158.

The four broad stages of data indexing 102, query expansion 104, relevant chunk search 106, and answer generation 108 are described below. For purposes of explanation, the description includes comparisons and contrasts with the corresponding stages of graph-based RAG pipelines and their various search capabilities.

The data indexing stage 102 starts with source documents 110 (e.g., a dataset). The source documents 110 are divided into text chunks 112 by chunking at 160. The content of the text chunks 112 overlap one another. The process can set an initial size of the text chunks 112. As will be described in more detail below, the text chunk size may be dynamically changed and the process repeated. The text chunks 112 are utilized for two different and parallel parts of the process. First, the text chunks 112 are embedded at 162 to produce chunk embeddings 114. In parallel, the text chunks 112 are analyzed to identify chunk concepts 116.

Chunk embedding 114 can be achieved using standard text embedding techniques to create vector-based representations of the text. Thus, as used herein, embedding means representing data in a continuous vector space while preserving data relationships. This is a low resource usage process and is called ‘lazy’ because it can be accomplished without use of a generative model (e.g., LLM) in the data indexing stage 102. The use of the LLM can be deferred until query time and thus be reserved for those user input queries that are actually received rather than attempting to proactively spend LLM resources to broadly cover all user input queries that may be received.

In the second text chunk process, recall the text chunks 112 are used to generate chunk concepts 116. This is accomplished by extracting concepts from the text chunks 112. As used herein, concepts are filtered noun phrases, such as ‘table’ and ‘chair’ as well as any named entities, such as ‘George Washinton’ or ‘Seattle.’

Link aggregating 164 of the chunk concepts 116 contributes to a raw concepts graph 118. Aggregating links entails identifying concept co-occurrence in an individual text chunk 112. If two concepts co-occur in the chunk concepts 116 of an individual text chunk 112, then a link or edge is created between them. If additional co-occurrences are detected in the chunk concept (e.g., a link has already been established), then a weight of the link is increased for each additional co-occurrence. This produces the raw concepts graph 118 based on counts of concept co-occurrence across the text chunks 112 of the source documents 110.

The data indexing stage includes modularity tuning 166 of the raw concepts graph 118 to generate a tuned concepts graph 120. As used herein, ‘modularity’ means relatively dense clusters of concepts within the graph that are separated by relatively sparse regions. As introduced above, the tuning 166 can be achieved by dynamically adjusting chunk size (e.g., from the first chunk size to a second different chunk size). This technical solution can dynamically adjust chunk size to produce desired graph properties (e.g., modularity).

The data indexing stage 102 provides a technical solution that auto-tunes the modularity of the concept graph towards a target modularity of 0.7, for example. This modularity represents a balance between clustering and overall connectivity and creating a well-defined community structure. This auto-tuning can be performed using a hyperparameter sweep that encompasses a co-occurrence window and overlap sizes, as well as filtering by node frequency, node degree, and/or edge weight. Thus, the data indexing stage 102 generates and refines graphs (e.g., raw concepts graph 118 into tuned concepts graph 120) that represent the semantic structure of the source documents 110.

Next, partition inferring 168 is performed on the tuned concepts graph 120 to identify concept communities 122. Partition inferring divides the tuned concept graph into communities of closely related groups of concepts that represent different topics. Thus, the communities represent topics which are referred to as concept communities 122. For instance, the tuned concepts graph 120 can be translated into a hierarchical community structure (e.g., concept communities 122), such as by using a hierarchical version of the Leiden algorithm, among other techniques. The process includes allocating or assigning text chunks 170 to their closest community to make community chunks 124. To summarize some of the description above, an individual text chunk can contain multiple concepts that the process extracts from it. The extracted concepts form the concept communities 122. The individual text chunk can then be assigned to the community that has the most matching concepts.

The final indexing step, unique to LazyGraphRAG, is to perform a fuzzy clustering of community chunks 124 by mapping them to all related concept communities 122. This is achieved by mapping the concepts of each chunk to their communities, then aggregating all chunks linked to each community. These groups of conceptually-related chunks can play a key role in the later search for query-relevant source text during the relevant chunk search 106. This then marks the end of the data indexing stage-no community summaries, or indeed any kind of LLM use, is required until the query stages to follow. This deferred LLM use brings the “lazy” quality to the overall approach.

The data indexing 102 provides a technical solution that generates dynamically sized text chunks and produces concept graphs for the text chunks without incurring the high resource usage associated with employing a generative model, such as an LLM. Instead, the data indexing process extracts concepts from the text chunks and generates graphs from the concepts. This technical solution provides performant results, even with potentially nosier graph structures. The concept graphs convey effective modularity (e.g., dense regions clumping together and separated from other regions). This technical solution provides a semantic map of the source content (e.g., source documents 110) so each of those groups or communities describes a relatively distinct topic area. This technical solution provides more efficient computer performance by not consuming resources on LLM calls that may in the end be unneeded or unused (e.g., making summaries that relate to concepts about which the user never queries).

In contrast, with existing graph-based RAG analysis of text chunks is a highly intensive process requiring multiple rounds of LLM use to build entity, relationship, and community summaries. Requiring such a comprehensive data index before being able to answer a single query represents a substantial up-front resource cost in terms of time and LLM text completion calls, and can present a major barrier to use.

In contrast with existing techniques, with the current LazyGraphRAG concepts, data indexing is very fast and almost free-incurring only the costs of text embedding for each source document chunk (i.e., the same as standard vector-based RAG). One of the differences is that LazyGraphRAG uses fast natural language processing (NLP) methods to extract noun phrases from chunk concepts 116, then constructs a simple concept co-occurrence graph (e.g., raw concept graph 118 and then tuned concept graph 120) as the semantic map of the source documents 110. In contrast, existing graph-based RAG techniques construct an entity relationship graph with description covariates that is much more resource intensive to construct.

Data indexing stage 102 provides a way to go from the source documents (dataset) and its text chunks to groups of related chunks that represent discrete topics in the data without using any LLMs. Instead, the process uses noun phrase extraction to create concepts. This process is very fast and utilizes relatively few resources. The process may create a noisy graph but any potential disadvantages can be minimized by tuning the graph using graph statistics.

Note also that the data indexing processes described above also work for streaming data (e.g., a temporally changing dataset). For instance, if the dataset receives a new document, the process can break the new document into chunks, extract the concepts from the chunks, add concepts to the existing graph, and assign new chunks to communities. So, the data indexing stage can support streaming without summarization of the dataset. Thus, a temporally changing dataset can be readily processed utilizing the data indexing techniques described above and without employing a generative model.

The description now turns to query expansion stage 104, which entails blocks 126-138. The query expansion stage starts with receiving user (input) query 126. The query expansion stage includes decomposing 172 the user query 126 into decomposed sub-queries (DCS) 128. The decomposition can be achieved with a generative model, such as an LLM.

One purpose of the decomposition is that often the user query 126 does not look anything like the data of the source documents 110. Many user queries or at least many answers benefit from having different parts that address different parts of the user query. For instance, users can ask questions that are vague and need decomposition into more concrete queries or they can ask complex queries that explicitly have multiple parts that can be answered independently. Either way it can be helpful to be able to take the user query and decompose it into several sub-queries. For instance, three to five sub-queries provide flexibility for addressing different aspects of the user query. The decomposed sub-queries 128 can contribute to an expanded query 136.

In parallel to the query expansion stage 104, embedding 174 can be performed on the decomposed sub-queries 128 to produce DSQ embeddings 130. The DSQ embeddings 130 provide a form of the user query 126 that is readily comparable to the language of the source documents 110 as will be explained immediately below.

Performance of the query expansion stage 104 can be enhanced by rewriting the user input queries 126 in the language of the data (e.g., the source documents 110). The query expansion stage 104 can match the user input queries 126 to the data of the source documents 110. The decomposed sub-queries 128 are not in the language of the data. Instead, decomposed sub-queries 128 are in the language of the LLM that performed the decomposition and its interpretation of the user query 126. However, as mentioned above the decomposed sub-queries are embedded to produce decomposed sub-query (DSQ) embeddings 130, which can be more readily compared to the source documents 110.

Recall that part of the data indexing stage produced chunk embeddings 114. The DSQ embeddings 130 can be matched at 178 or otherwise compared to the chunk embeddings 114 to produce DSQ chunks 132. For instance, an individual DSQ chunk 132 can be associated with an individual decomposed sub-query 128. If the DSQ embeddings 130 of that DSQ chunk 132 have a high degree of similarity (e.g., match) with an individual chunk embedding 114, then that DSQ chunk 132 is related to the corresponding text chunk 112. This comparison identifies the individual text chunks 112 that are related to individual decomposed sub-queries 128.

Recall that the data indexing 102 also links text chunks 112 to concepts in the tuned concept graph 120. The tuned concept graph 120 of the related text chunks 112 can be used for concept matching with the DSQ chunks 132 to identify DSQ concepts 134. Stated another way, at this point, the concepts of the related text chunk 112 can be representative of concepts for the DSQ chunk 132.

To summarize, for a given user query 126 (via its decomposed sub-queries 128) query expansion 104 can obtain a list of DSQ concepts 134 from the tuned concept graph 120. The decomposed sub-queries 128 and the DSQ concepts 134 can be provided to a generative model to produce augmented sub-queries 138. In essence, the query expansion stage 104 can provide the LLM with decomposed sub-queries 128 and DSQ concepts 134 that may be relevant as a way of expanding, refining, and/or giving examples, and ask the generative model to make this more understandable and rich as a query. Stated another way, the query expansion stage 104 can prompt the LLM to rewrite this query to include any of the relevant ideas in this list (decomposed sub-queries 128) augmented with concepts from the tuned concept graph 120 to form DSQ concepts 134. The output of the LLM is the augmented sub-queries 138.

Note that decomposed sub-queries 128 provide different aspects of the user query 126 but they are not yet in the language of the data (e.g., the source documents 110). The sub-queries can be decomposed and embedded to produce DSQ embeddings 130. Data indexing stage 102 provides chunk embeddings 114. The query expansion stage 104 can utilize proximity to identify text chunks 112 that look similar to the decomposed sub-query embeddings 130. The query expansion stage can look at those text chunks for related concepts. Those DSQ concepts 134 can be ranked based on both their role in the tuned concept graph 120 and their closeness or similarity to the decomposed sub-queries. For example, concepts that link to more concepts are generally more important than more isolated concepts and it is also generally important for concepts to be closer to the decomposed sub-query 128 and its DSQ embeddings 130. Those two factors are both considered to create an overall ranking of which concepts can be used to augment this sub-query.

The query expansion stage 104 presents the generative model with the decomposed sub-query 128 and those DSQ concepts 134. The generative model rewrites the sub-query and the result is an augmented sub-query 138. The term ‘augmented sub-query’ is used because it is a sub-query that is augmented with language from the tuned concept graph 120, which is anchored in the source documents 110. This process is repeated for each decomposed sub-query 128.

A specific query expansion stage 104 implementation is now described. This implementation employs query decomposition 172 to the input query 126. Note that this query decomposition process is informed by the tuned concept graph 120. For example, given user query 126, an LLM is first used to decompose the user query into 1-N sub-queries (default N=5) representing different aspects or parts of the user input query. These decomposed sub-queries 128 are then embedded at 174. The resultant DSQ embeddings 130 are used to retrieve the top-s most similar DSQ chunks 132 for each community of the tuned concept graph 120. The retrieval can occur at a specified level Hx in the community hierarchy (default x=1, i.e., the first level of partitioning below H0, which represents the entire graph). Linked concepts are scored using the mean reciprocal rank of (a) their similarity to the user query and (b) their degree in the concept graph. The top-k of these concepts (default c=15) are then provided as context to an LLM call that augments each decomposed sub-query with relevant concepts as augmented sub-queries 138, i.e., rewrites the query in the language of the data in a way that encourages better query-chunk matching. The same LLM call also recombines these sub-queries into a single expanded query 136.

One aspect of query expansion stage 104 is generating the expanded query 136 and the augmented sub-queries 138 in parallel to one another at the same time. The expanded query 136 is generic to the knowledge of the LLM. The expanded query 136 will be used subsequently for generating the final answer 158. The augmented sub-queries 138 are related to the source documents 110. Each of the augmented sub-queries 138 are delivered to the relevant chunk search 106 for query processing 182.

The relevant chunk search 106 processes user query 140 (e.g., user query 126 of query expansion 104) by embedding the query at 184 to generate query embeddings 142. At this point, recall that the user query is manifest as the augmented sub-queries 138 received from query expansion 104. Thus, the query embedding 184 creates a vector-based representation of the user query 140. Next relevant chunk search 106 compares for similarity (e.g., ranking 186) query embeddings 142 to the chunk embeddings 114 produced during data indexing 102. This comparison produces ranked chunks 144 from the dataset based on the similarities to the query. With the ranked chunks 144, the top one is likely the best one to answer the query.

However, also recall that data indexing 102 also organized the chunk embeddings 114 into concept communities 122. This allows the relevant chunk search process 106 to map each community 122 to the average rank of its ranked chunks 144 and then use that to rank the communities to get a list of ranked communities 146. This maintains a best-first search order but at the community level. Thus, if the process goes to a community to answer the user input query, it knows which is the best community, and what is the next best community, etc. Note that the process has multiple levels of communities organized as a hierarchy of communities. Relevant chunk search 106 can apply this process at each level in the hierarchy. There is a ranking for the top level of communities, a ranking for the next level, etc. Relevant chunk search 106 can do this for each level to get a reprioritized data structure and then start traversing to look for relevant chunks. Relevant chunk search 106 can employ mining of the ranked communities 190 to identify relevant chunks 148. The most relevant chunk is the most relevant chunk in the most relevant community. So relevant chunk search 106 begins similarly to semantic search and starts at the root level of the hierarchy. The root level can be viewed as all the chunks at all of the communities—the whole dataset is like one big community.

To review the description above, LazyGraphRAG can start out by identifying a number (e.g., the top k) text chunks 112 in the source documents 110 as a whole. That is also how semantic search works but semantic search assumes the relevance of those text chunks. Semantic search just takes the top k in the embedding and takes the text chunks that represent the vectors and gives them to the context window of the LLM and so that the LLM can generate an answer. However, the LLM never actually checks the relevance of those text chunks. In contrast, the current query expansion stage 104 includes a process that says for each of those communities, the process is going to have the graph structure of the tuned concept graph 120 and the chunk embeddings 114 combined to nominate the relevant text chunks 112. The query expansion stage 104 can ask the LLM if these are the most relevant text chunks. If the LLM says a text chunk is relevant, then the process keeps it as a relevant chunk 148. The query expansion process does that for each of the decomposed sub-queries 128 in parallel to create one big set of relevant text chunks 148. Thus, relevant chunk search 106 progresses from the input query 126, breaks it up into decomposed sub-queries 128, finds relevant chunks 148 for the decomposed sub-queries 128 in a novel way, and puts them all together ready to proceed to answer generation.

Note that the existing full graph-based RAG global search algorithm uses a comprehensive breadth-first search process-every query is answered using all community summaries at a fixed level in the community hierarchy. However, a recent extension to the global search method introduces a relevance-driven search process based on dynamic community selection. An LLM is used to rate the relevance of each root-level community summary with respect to the input query, with the search process recursing into the child community summaries of each relevant community until a final set of relevant community summaries is reached. The answer to the query is then generated via map-reduce query-focused summarization over this subset of communities, which can span multiple levels of the hierarchy.

LazyGraphRAG takes this approach even further by prioritizing community relevance tests in presumed order of community relevance. Given a user input query, embedding the query within the space of text chunk embeddings first provides a “best-first” ranking for relevant chunk search based on query-chunk similarity. Using the chunk-community mappings computed in the data indexing stage, this then allows for a derived “best-first” ranking of communities at each level of the community hierarchy, based on the mean rank of their top-n chunks in the chunk ordering.

The relevant chunk search stage 106 of the LazyGraphRAG pipeline 100 thus proceeds over each augmented sub-query in parallel, first creating ranked community-chunk structures in the manner described above, then using these structures to mine for relevant text chunks in breadth-first style following the iterative-deepening graph search presented in Algorithm 1. There are three potentially key parameters including testBudget, testQuota, and iterateThreshold.

testBudget represents the maximum number of relevance tests permitted on input text chunks before returning the set of relevant chunks. Higher budgets will tend to yield more chunks.

testQuota represents the number of relevance tests to run for each community in best-first order, testing the top-testQuota previously untested text chunks in their own best-first order.

iterateThreshold represents the number of successive communities yielding zero relevant chunks required to trigger iterative deepening at the next level in the community hierarchy, if it exists. If it does not exist (e.g. else) then trigger a repeat pass over the current (terminal) community level.

Together, these parameters control a “lazy” search for query-relevant text content that greedily mines the most relevant chunks and communities while terminating as soon as relevance tests begin to fail.

While testQuota and iterateThreshold can generally be held constant, testBudget is intended to offer a simple variable for controlling answer cost and quality. Lower test budgets will yield cheaper and faster answers with relatively less answer detail, while higher budgets will yield significantly richer answers for relatively greater cost. Some of the goals of the algorithm are summarized below.

The first goal is to provide a single search mechanism that dynamically adapts to the location of the query on the local-global spectrum by blending best-first VectorRAG and breadth-first graphRAG. The second goal is for low test budgets. Relevant text chunks can be selected in a way that approximates VectorRAG for local queries, yet introduces topical diversity for global queries. The third goal is for higher test budgets. Relevant text chunks can be selected in a way that terminates early for local queries, yet approximates GraphRAG Global Search for global queries.

A potential advantage of the resulting algorithm compared to VectorRAG is that the text chunks with the most similar embeddings to the query are not assumed relevant and selected by default-they are subject to an additional LLM-based relevance test that maximizes the signal-to-noise ratio in the resulting text chunks used as context for answer generation. A corresponding advantage compared to graph-based RAG is that the answer context is not limited to community summaries of entity and relationship summaries, but includes the full details of relevant source text chunks.

The LLM-based relevance tests applied to text chunks build on this idea of maximizing the signal-to-noise ratio in the context passed to an LLM for answer generation. Rather than providing a binary relevant/irrelevant judgment, they provide three-way classification at the sentence level: irrelevant (score=0), indirect relevance (score=1), and direct relevance (score=2). Only text chunks with a score of 1 or more are considered relevant overall.

The cost differential of input and output tokens means that these relevance tests are relatively economical compared with generating verbose outputs over irrelevant inputs. The simplicity of the task also makes it suitable for less capable or fine-tuned models in a mixed-model pipeline.

Algorithm 1 Iterative Deepening Graph Search for Lazy Mining of Relevant Text Chunks
Input: query; a hierarchy of graph communities H₀ . . . H_{N} (H₀ = all chunks) with each level
ranked in best-first order with respect to the query; testBudget; testQuota; iterateThreshold
Output: relevantChunks judged by an LM as relevant to query

```
  1 Initialize relevantChunks ← Ø, communityPassed ← False, levelPassed ← False,
    failed ← 0, tested ← 0, i ← 0, discarded ← Ø [symbol]   (level, index) community tuples
  2 while i ≤ N do
  3 levelPassed ← False
  4 for j = 0 to number of communities in Hᵢ do
  5 if (i, j) E discarded then continue
  6 if (i > 0 and parent (Hᵢ |j|) E discarded) then
  7 Add (i, j) the discarded [symbol]   Parent is discarded; discard community
  8 continue
  9 Select testQuota untested chunks from community Cⱼ in Hᵢ in best-first order
10 Use LM to judge relevance of selected chunks
11 communityPassed ← False
12 for each chunk c in selected chunks do
13 if chunk c is judged relevant then
14 communityPassed ← True
15 levelPassed ← True
16 Add c to relevantChunks
17 tested ← tested + 1 [symbol]   Increment count of tested chunks
18 if tested = testBudget then return relevantChunks [symbol]   Budget reached; return
19 if communityPassed then failed ← 0 [symbol]   Reset count of successive failures
20 if not communityPassed then
21 failed ← failed + 1 [symbol]   Increment count of successive failed communities
22 Add (i, j) to discarded [symbol]   No relevant chunks; discard community
23 if failed = iterateThreshold then break [symbol]   Assume remaining not relevant; iterate
24 if levelPassed and i < N then i ← i + 1 [symbol]   Iterate at next level if available, else repeat
25 if not levelPassed then return relevantChunks [symbol]   No new relevant chunks; return
26 return relevantChunks
```

The description now turns to answer generation stage 108. The answer generation stage starts with link aggregating 192 of the relevant chunks 148 generated by the relevant chunk search stage 106. Link aggregating establishes links, and the weight of the links, between concepts in the relevant chunks 148 to generate focused graph 150. Chunk concepts 116 from the source documents 110 are applied to the focused graph 150 to facilitate partition inferring 194. This step divides the focused graph 150 into focused communities 152. The focused communities are closely related groups of concepts that represent different topics. The answer generation stage includes allocating 196 focused communities 152 to batched chunks 154. This step allocates relevant chunks 148 to their closest community of the focused communities 152.

Answer generation stage 108 utilizes an LLM prompt for mapping 198. The LLM prompt used in the mapping stage 198 of the answer generation process aims to further increase the signal-to-noise ratio in the context to generate final answer 158. Generating partial answers as narrative text carries substantial structural and rhetorical overheads. Instead, the batched chunks 154 are processed by the LLM into corresponding batched claims 156. Each claim is supported by a list of all supporting text chunks 112. Individual batched claim 156 are then ranked based on a combination of their LLM-assigned importance score (generated in this step) and the sum of LLM-assigned relevance scores for the sentences of all supporting source chunks (generated during chunk relevance testing (e.g., mining step 190 identifying relevant chunks 148)). Hallucinated claims with no valid supporting source IDs receive a low ranking and are filtered out.

The final step of answer generation stage 108 involves final claim reduction 199. This step can be performed as a single LLM call that takes the expanded query 136 and lists of batched claims 156 (e.g., sub-query-linked claims) as input. Each decomposed sub-query 128 is assigned an equal share of the context window for its claims, which are ranked and truncated accordingly. The final answer 158 is then generated as narrative text with embedded references to source chunk IDs throughout.

With graph-based RAG global search, community summaries are randomly shuffled and partitioned into batches in preparation for map-reduce question answering. This means that the more communities that are relevant, the more frequently the map answers contain relevant content for the final answer, and the more likely this content is likely to be retained by the final reduce process.

This approach makes sense for graph-based RAG global search since there is no prior notion of community or content relevance. With LazyGraphRAG, however, the pipeline already knows that all of the relevant text chunks should play a role in shaping the final answer. It is therefore better for the processes to group relevant subsets of text chunks together so that they may be analyzed as a coherent whole.

Answer generation in LazyGraphRAG continues via the parallel processes that have mined relevant text chunks 148 for each sub-query. Within each process, relevant text chunks 148 are first used to retrieve concept co-occurrence links, which are then aggregated to build focused concept graph 150. Next, hierarchical community detection over this graph is used to identify the leaf communities of this structure, representing focused sets of concepts that can be used to group related text chunks.

The prompt used in the map stage of the answer generation process aims to further increase the signal-to-noise ratio in the context to generate the final answer 158. Rather than generating partial answers as narrative text, which carries substantial structural and rhetorical overheads, the batched chunks 154 are instead processed by the LLM into corresponding batched claims 156 (e.g., batches of claims), with each claim supported by a list of all supporting text chunks. Claims are then ranked based on a combination of their LLM-assigned importance score (generated in this step) and the sum of LLM-assigned relevance scores for the sentences of all supporting source chunks (generated during chunk relevance testing). Hallucinated claims with no valid supporting source IDs are filtered out.

As mentioned above, the final reduce step is performed as a single LLM call that takes the expanded query 136 and lists of sub-query-linked claims (e.g., batched claim 156) as input. Each sub-query is assigned an equal share of the context window for its claims, which are ranked and truncated accordingly. The final answer is then generated as narrative text with embedded references to source chunk IDs throughout.

Here, and across all stages of the LazyGraphRAG pipeline 100, the systematic elimination of redundant LLM tokens further contributes to the “laziness” established by deferring LLM use until query time.

Evaluation comparing varying configurations of LazyGraphRAG to a range of competing methods across a range of datasets, queries, and metrics, demonstrates the ability to scale answer quality with more capable models and increased relevance test budgets, and all within a very low cost range. For example, in the lowest-cost configuration, with a small relevance test budget and less capable model (gpt-40-mini), LazyGraphRAG always provided superior query cost, answer quality, or both-without ever losing on answer quality to any other method. In an example for the highest-cost configuration, with a large relevance test budget (1500) and more capable model (gpt-40), LazyGraphRAG achieved statistically significant win rates against all competing methods for all metrics, including the most-capable version of GraphRAG Global Search for global questions, and the standard VectorRAG (with 8k token context window) for local questions.

Overall, LazyGraphRAG provides a unified RAG mechanism that is highly suitable to large-scale or streaming data requiring immediate or global analysis, and all at comparable costs to VectorRAG.

To review some of the description above, the process starts out by identifying a number of relevant text chunks in the dataset as a whole. That is similar to how semantic search works, but semantic search assumes the relevance of those text chunks Semantic search just takes a number of the embeddings and takes the text chunks that represent the vectors. Semantic search gives them to the context window of the LLM and generates an answer. However, semantic search never actually checks the relevance of those text chunks. In contrast, the present solutions include a process for each of those communities that combines the graph structure and the embeddings to nominate what are likely the relevant text chunks. The current process then goes a step further to ask the LLM if they are in fact relevant. If the LLM says a text chunk is relevant, then the current process keeps it as a relevant chunk. The current process does that for each of the sub-queries in parallel to create one big set of text chunks. This solution goes from the input query, breaks the input query up into sub-queries, finds relevant chunks for the sub-queries in a clever way, and puts them all together ready to proceed to answer generation.

Semantic search in general and vector RAG are best-first approaches. These existing processes embed the query and embed the text chunks. The best result to use is the top one and the next best is the next one down based on the matching in vector space This can work well for local queries where the query resembles the answer. The existing techniques create a technical problem because they do not work well for global questions. Graph-based RAG is directed to situations where the query doesn't look like the answer. One such example is where the query is asking about some characteristic or item of the dataset as a whole. Graph-based RAG is a breadth first approach, regardless of the query all of the communities are asked to generate a partial answer and the partial answers are aggregated into the final answer. Graph-based RAG's breadth first approach creates a technical problem because it is very resource intensive. The best-first approach of vector RAG does not know anything about the breadth of the dataset and Graph-based RAG does not ask which is the best to answer the query. The present LazyGraphRAG concepts provide a technical solution that blends these best-first and breadth first approaches in the way that makes the most sense. The present LazyGraphRAG concepts start out better than vector RAG for local questions and then very quickly approximates the characteristics of graph-based RAG for global questions but with substantially lower resource consumption.

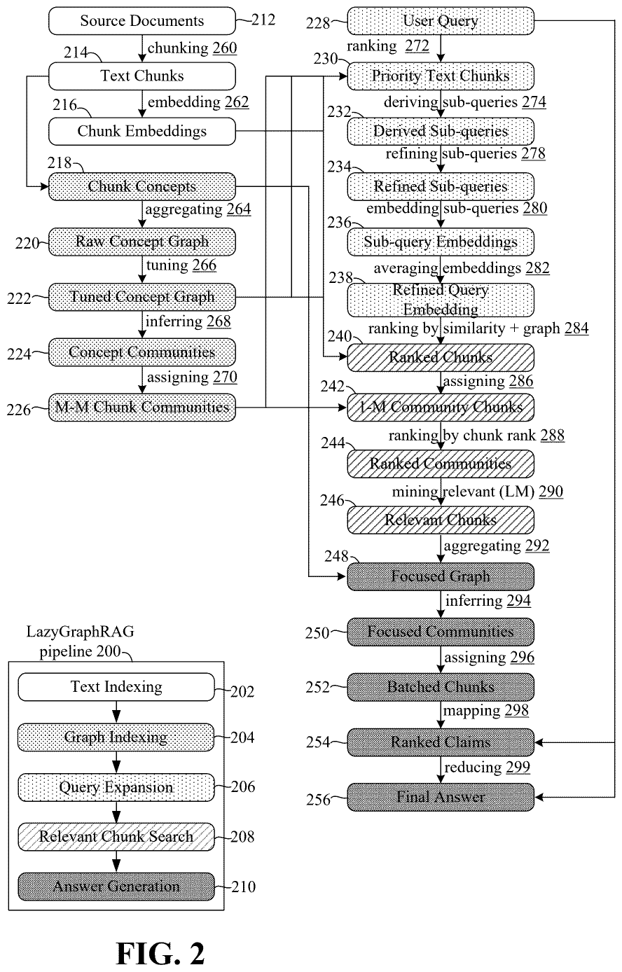

FIG. 2 shows another example LazyGraphRAG pipeline 200 that is configured to implement some of the present concepts. The LazyGraphRAG pipeline 200 includes five broad stages entailing data/text indexing stage 202, graph indexing stage 204, query expansion stage 206, relevant chunk search stage 208, and answer generation stage 210. Data or text indexing stage 202 entails blocks 212-216. Graph indexing stage 204 entails blocks 218-226. Query expansion stage 206 entails blocks 228-238. Relevant chunk search stage 208 entails blocks 240-246. Answer generation stage 210 entails blocks 248-256.

LazyGraphRAG text indexing stage 202 can be similar to Vector RAG: source documents are first converted into text chunks that represent appropriately-sized units for retrieval, before these text chunks are augmented with any necessary metadata (e.g., document title, date) and converted into vectors using a text embedding model. While the GraphRAG library supports such text indexing, it is only used in its Local Search and Drift Search query methods, and not in the Global Search method of query-focused summarization.

Text indexing stage 202 is similar to data indexing 102 of FIG. 1 and as such is only briefly described here. In this implementation, source documents 212 are chunked at 260 into text chunks 214. The text chunks 214 are embedded at 262 to generated chunk embeddings 216. The text chunks 214 are also utilized by the graph indexing stage 204. The chunk embeddings 216 are fed forward for use by the query expansion stage 206 and the relevant chunk search stage 208.

In LazyGraphRAG pipeline 200, graph indexing 204 broadly follows the same pattern as GraphRAG: text chunks are analyzed to construct a graph that represents the semantic structure of the source documents, and the graph is translated into a hierarchical community structure using a hierarchical version of the Leiden algorithm.

As mentioned above, with GraphRAG, analysis of text chunks is a highly intensive process requiring multiple rounds of LLM use to build entity, relationship, and community summaries. Requiring such a comprehensive data index before being able to answer a single query represents a substantial up-front cost in terms of time and LLM text completion calls, and can present a major barrier to use.

With LazyGraphRAG, however, data indexing is fast and almost free-incurring only the costs of text embedding for each source document chunk (i.e., the same as Vector RAG). The difference is that LazyGraphRAG uses NLP methods (noun phrase and named entity extraction) to extract concepts from text chunks, then constructs a simple concept co-occurrence graph (rather than an entity relationship graph with description covariates) as the semantic map of the source documents. No community summaries, or indeed any kind of LLM use, is employed until the query stages to follow. It is such deferred LLM use that brings a “lazy” quality to the overall approach.

Specifically, graph indexing 204 starts by generating chunk concepts 218 from text chunks 214. The chunk concepts 218 are fed forward to the answer generation stage 210. The chunk concepts 218 are aggregated at 264 to form raw concept graphs 220. The raw concept graphs 220 are tuned at 266 into tuned concept graphs 222. The tuned concept graphs 222 are inferred at 268 to produce concept communities 224. The concept communities 224 are assigned at 270 to many-to-many (M-M) chunk communities 226. The M-M chunk communities 226 are fed forward to the query expansion stage 206 and the relevant chunk search stage 208.

One insight here is that rich entity and relationship descriptions are only necessary for GraphRAG Local Search, in which embeddings of entity descriptions are used to match the query to “entry points” in the entity relationship graph. For GraphRAG Global Search, however, the most important part of the index is the hierarchical community structure. The precise nodes and edges are therefore less consequential than the modularity of the graph as a whole, since better modularity represents a cleaner partitioning of the graph into topics that can be analyzed independently.

Since the concepts and co-occurrences extracted by LazyGraphRAG indexing are inherently more noisy than the curated entities and relationships extracted by GraphRAG indexing, additional tuning of the concept co-occurrence graph is utilized for a modular partitioning to emerge. The first step is converting raw co-occurrence counts into a variant of pointwise mutual information designed to reduce the impact of low-frequency, high-information events. This has the effect of down-weighting two kinds of noisy edges: those from high-frequency concepts that indiscriminately connect to nodes across the graph, and those from clusters of low-frequency concepts with high mutual information but low importance overall. Conceptually, the resulting edges may be pruned in ascending weight order until a target modularity is reached. In practice, LazyGraphRAG performs a parallelized hyperparameter sweep over preset edge-cut percentages and selects the graph that exceeds the target modularity by the smallest degree. By default, LazyGraphRAG uses edge-cut percentages of 0%, 20%, and 40% and a target modularity of 0.7, representing a balance between global connectivity and local community structure.

The final indexing step, unique to LazyGraphRAG, is to create a many-to-many (M-M) mapping between chunks and communities as M-M chunk communities 226. This is achieved by mapping chunks to the set of communities represented by their extracted concepts, then aggregating all chunks linked to each community. These groups of conceptually-related chunks play a key role in the later search for query-relevant source text (e.g., priority text chunks 230).

Query expansion stage 206 offers a way to expand an input query in a manner that adds detail and diversity, informed by both the general knowledge of the LLM and the specific content of source texts. In this implementation, query expansion stage 206 involves ranking 272 a user (input) query 228 to produce priority text chunks 230. Chunk embeddings 216 and M-M chunk communities 226 are utilized to derive sub-queries at 274 from the priority text chunks 230 to produce derived sub-queries 232. The derived sub-queries 232 are refined at 278 to produce refined sub-queries 234. The refined sub-queries 234 are embedded at 280 to produce sub-query embeddings 236. The sub-query embeddings 236 are averaged at 282 to produce refined query embeddings 238.

While GraphRAG Global Search does not have any in-built mechanism for query expansion, GraphRAG Drift Search is based on the idea that a broad answer generated from the top-k most similar community reports to the input query provides useful context for the generation of follow-on local queries.

LazyGraphRAG also supports query decomposition as an extension to the core algorithm. The approach can be viewed as running a simplified, LLM-free version of the full relevant chunk search process to retrieve a prioritized set of text chunks (e.g., priority text chunks 230) most likely to contribute to a high-quality answer, then using these priority text chunks 230 to create a “pseudo-answer” for sub-query generation (like Drift Search).

The selection of priority text chunks 230 benefits from combining the “best-first” search results of Vector RAG, which are ideal for local search queries, with the “breadth first” results of GraphRAG Global Search, which are ideal for global queries addressing the many communities that make up the dataset. Text chunk selection can also exploit the tuned concept graph to ensure that the selected text chunks are the best examples of their communities and the dataset as a whole.

This process of selecting priority text chunks 230, begins by resolving the multiple community memberships (from M-M chunk communities 226) of each text chunk into a single query-specific community. Text chunks are first ranked at 272 by vector similarity to the query, before the mean ranks of the top-k text chunks in each community (default k=15) are used to rank the communities themselves. Each chunk then takes on the single community from its community list with the highest rank for the input query.

Given the resulting community assignments, LazyGraphRAG uses Reciprocal Rank Fusion (RRF) technique over three different criteria to create a final ranked chunk list. This is represented in the relevant chunk search stage 208 as ranked chunks 240.

The text chunk ranking can include three parameters: Vector similarity by community; Matching concept representation; and Frequent concept representation. In vector similarity by community, all text chunks are ranked by vector similarity to the user query 228 and then filtered to the top-k chunks from each top-level community (default k=15).

In matching concept representation, noun phrases are extracted from the user query 228 and matched with concepts from the tuned concept graph 222, from which the method retrieves neighboring concepts. Text chunks are then ranked by aggregate combined edge weights for matching concept pairs.

In frequent concept representation, filtered text chunks are ranked by the aggregate degree of their extracted concepts in the tuned concept graph 222.

Text chunks are taken from this list up to a predefined token limit to create a priority text list. This is used as context in an LLM call that generates both a pseudo-answer to the input query and candidate sub-queries informed by the combination of the query, priority text list, pseudo-answer, and world knowledge of the LLM. The pseudo-answer is then used as context for a second LLM call, along with a list of potentially-related concepts extracted from the priority text list, with the LLM asked to review and improve each sub-query and augment it with a list of actually-related concepts. Each sub-query and its related concepts are then converted to vectors using text embedding, with the weighted average of these vectors used to rank text chunks in the retrieval stage. Following the query aggregation approach, the method allocates a weight of 0.7 the input query and 0.3 shared among the sub-queries. If query expansion is not selected, then the text embedding of the raw input query is used instead.

The description now turns to the relevant chunk search stage 208. This stage begins by ranking the refined query embeddings 238 by similarity and graph at 284 to produce ranked chunks 240. The similarity is produced from the chunk embeddings 216 and the tuned concept graph 222. The ranked chunks 240 are assigned to M-M chunk communities 226 at 286 to generate I-M community chunks 242. The I-M community chunks 242 are ranked by chunk rank at 288 to produce ranked communities 244. The ranked communities 244 are mined at 290 to produce relevant chunks 246.

In the description above relative to LazyGraphRAG pipeline 100, the full GraphRAG Global Search algorithm 1 described uses a comprehensive breadth-first search process-every query is answered using all community summaries at a fixed level in the community hierarchy. However, a recent extension to Global Search in the GraphRAG library introduces a relevance-driven search process based on dynamic community selection. Here, an LLM is used to rate the relevance of each top-level community summary with respect to the input query, with the search process recursing into the child community summaries of each relevant community until a final set of relevant community summaries is reached. The answer to the query is then generated via map-reduce query-focused summarization over this subset of communities.

LazyGraphRAG aims to take this approach even further by prioritizing community relevance tests in presumed order of relevance. Since there are no community reports in LazyGraphRAG, the source text chunks of the community are used as a proxy for the relevance of the community as a whole.

As with the query expansion stage 206, relevant chunk search stage 208 resolves chunks to a single, query-specific community membership. It also utilizes a rank ordering of both communities and all source text chunks assigned to each community in order of presumed relevance. Reciprocal Rank Fusion (RRF) is again used over the same three criteria to create the final “best-first” chunk ranking including: Vector similarity by community; Matching concept representation; and Frequent concept representation.

Vector similarity by community involves ranking all text chunks by vector similarity to the query.

Matching concept representation combines the concepts extracted from the query and the concepts generated by the LLM in the query expansion step. Concepts that match entities in the graph are then assigned a weight equal to the degree of the matching entity. Concepts that are not in the graph are assigned a weight of one. The method then finds text chunks associated with these concepts (via exact keyword matching). Text chunks are then ranked by the combined weight of their associated concepts to produce ranked chunks 240.

Frequent concept representation involves ranking all text chunks by the aggregate degree of their extracted concepts in the tuned concept graph 222.

This best-first chunk ranking is used in conjunction with the query-specific chunk-community assignments to create a final “breadth first” community ranking for each level of the community hierarchy. Both rankings are then used in concert to mine for relevant text chunks following the iterative-deepening graph search presented in Algorithm 1. There are three potentially key parameters: testBudget; testQuota; and iterateThreshold. Together, these parameters control a “lazy” search for query-relevant text content that greedily mines the most relevant chunks and communities while terminating as soon as relevance tests begin to fail.

While testQuota and iterateThreshold can generally be held constant (default testQuota=15, iterateThreshold=3), testBudget is intended to offer a simple variable for controlling answer cost and quality. Lower test budgets will yield cheaper and faster answers with relatively less answer detail, while higher budgets will yield significantly richer answers for relatively greater cost. The goals of the algorithm can be summarized as follows:

Provide a single search mechanism that dynamically adapts to the location of the query on the local-global spectrum by blending best-first Vector RAG and breadth-first GraphRAG.

For low test budgets, select relevant text chunks in a way that approximates Vector RAG for local queries, yet introduces topical diversity for global queries.

For higher test budgets, select relevant text chunks in a way that terminates early for local queries, yet approximates GraphRAG Global Search for global queries.

A potential advantage of the resulting algorithm compared to Vector RAG is that the text chunks with the most similar embeddings to the query are not assumed relevant and selected by default-they are subject to an additional LLM-based relevance test that maximizes the signal-to-noise ratio in the resulting text chunks used as context for answer generation. A corresponding advantage compared to GraphRAG is that the answer context is not limited to community summaries of entity and relationship summaries, but includes the full details of relevant source text chunks.

The LLM-based relevance tests applied to text chunks build on this idea of maximizing the signal-to-noise ratio in the context passed to an LLM for answer generation. Rather than providing a binary relevant/irrelevant judgment, they provide three-way classification at the sentence level: irrelevant (score=0), indirect relevance (score=1), and direct relevance (score=2). Only text chunks with a score of 1 or more are considered relevant overall.

The cost differential of input and output tokens means that these relevance tests are relatively economical compared with generating verbose outputs over irrelevant inputs. The simplicity of the task also makes it suitable for less capable or fine-tuned models in a mixed-model pipeline.

The description now turns to answer generation stage 210. This answer generation stage 210 entails aggregating relevant chunks 246 and chunk concepts 218 at 292 to form focused graph 248. Inferring 294 of the focused graph 248 produces focused communities 250. The focused communities 250 are assigned at 296 to batched chunks 252. Mapping 298 of the batched chunks 252 to the user query 228 produces ranked claims 254. The ranked claim 254 are reduced in light of the user query 228 at 299 to produce final answer 256.

With GraphRAG Global Search, community summaries are randomly shuffled and partitioned into batches in preparation for map-reduce question answering. This means that the more communities that are relevant, the more frequently the map answers contain relevant content for the final answer, and the more likely this content is likely to be retained by the final reduce process 299.

This approach makes sense for GraphRAG Global Search since there is no prior notion of community or content relevance. With LazyGraphRAG, however, the process knows that all of the relevant text chunks should play a role in shaping the final answer. It is therefore better to group relevant subsets of text chunks together so that they may be analyzed as a coherent whole.

Answer generation 210 in LazyGraphRAG begins with the set of relevant chunks 246 identified during the relevant chunk search stage 208. These are first used to retrieve concept co-occurrence links from the tuned concept graph 222, which are then aggregated to build a focused concept graph 248. Next, hierarchical community detection over this focused concept graph 248 is used to identify the leaf communities of this structure, representing focused sets of concepts that can be used to group related text chunks.

The prompt used in the mapping process 298 of the answer generation stage 210 aims to further increase the signal-to-noise ratio in the context to generate the final answer 256. Rather than generating partial answers as narrative text, which carries substantial structural and rhetorical overheads, the batched chunks 252 are instead processed by the LLM into corresponding sets of claims, with each claim supported by a list of all supporting text chunks. Claims are then ranked to produce ranked claim 254 based on a combination of their LLM-assigned importance score (generated in this step) and the sum of LLM-assigned relevance scores for supporting source chunks (1 or 2, generated during chunk relevance testing). Claims with no valid supporting source IDs are filtered out.

The final reduce step 299 is performed as a single LLM call that takes the prompt, query, and ranked claim list as input (truncated to the context window token limit). The final answer 256 is then generated as narrative text with embedded references to source chunk IDs throughout.

Here, and across all stages of the LazyGraphRAG pipeline, the systematic elimination of redundant LLM tokens further contributes to the “laziness” established by deferring LLM use until query time.

### Example Graphical User Interfaces

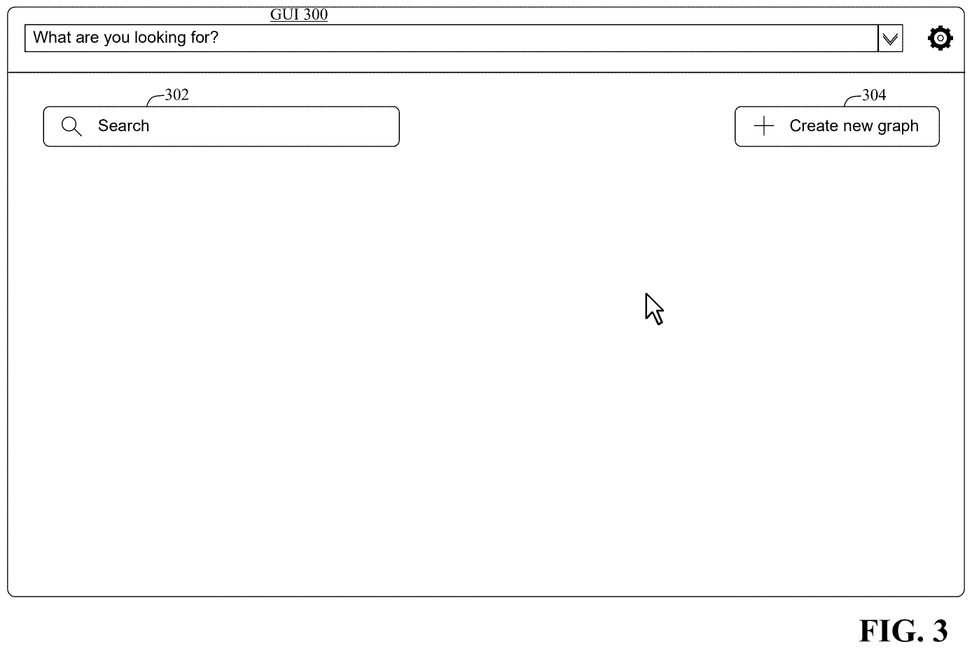

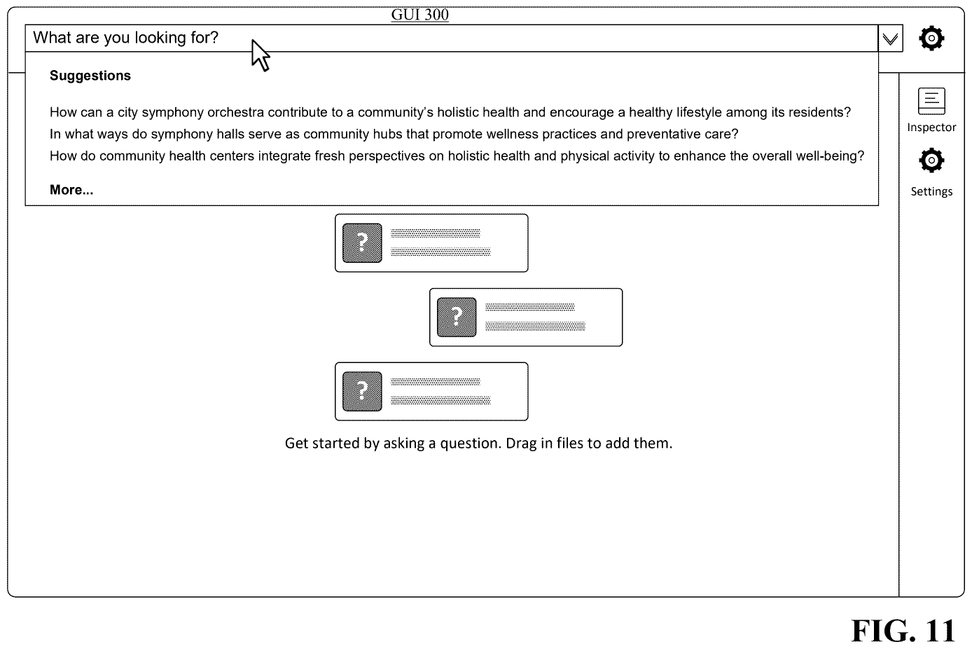

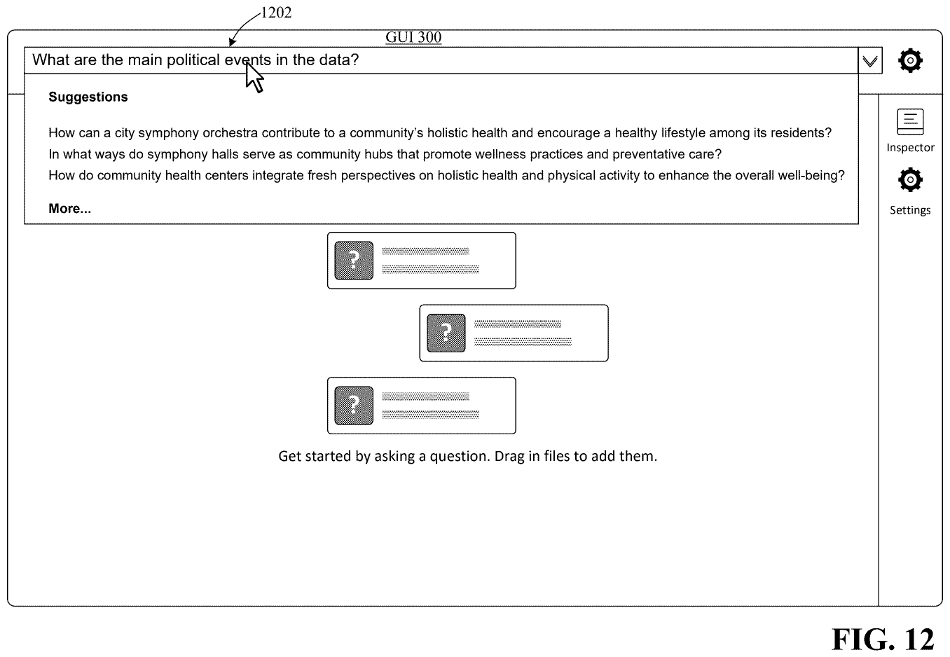

FIGS. 3-26 collectively show a user experience and features provided by the present LazyGraphRag concepts. FIG. 3 shows a graphical user interface (“GUI”) 300. The GUI can be generated by a LazyGraphRAG tool or agent. The GUI 300 offers several options to a user relating to a private dataset. (An example dataset is employed for purposes of explanation. The concepts described relative to this example dataset apply to other datasets.) The options include a search feature indicated at 302 and a create a new graph feature as indicated at 304. Assume for purposes of explanation that the user selects to generate a new graph.

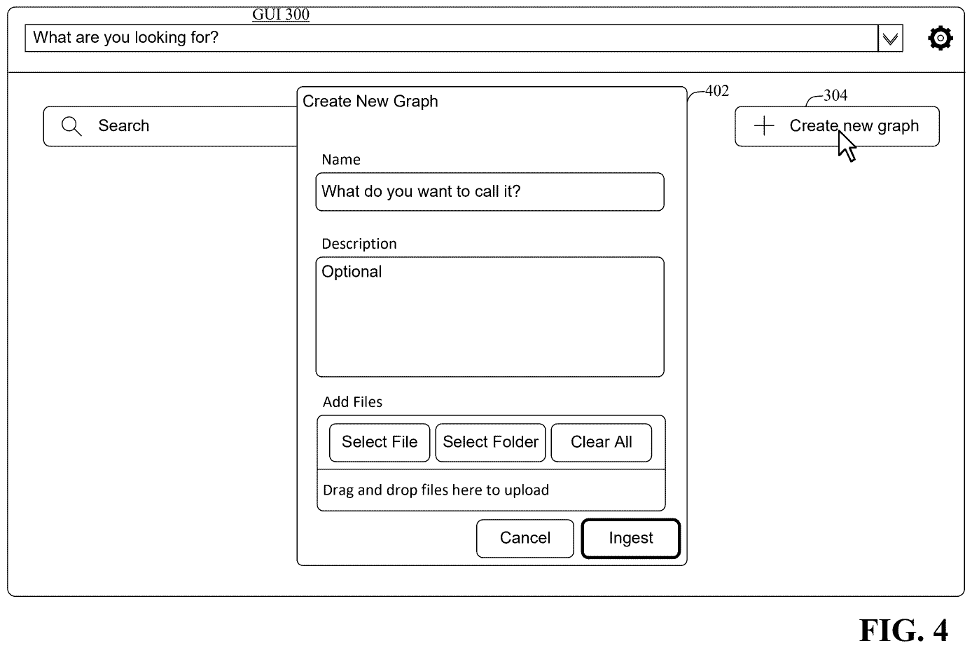

FIG. 4 shows the GUI 300 responsive to the user choosing to create a new graph by selecting the “create new graph” button 304. The GUI now includes options for the user to select regarding the new graph as indicated at 402.

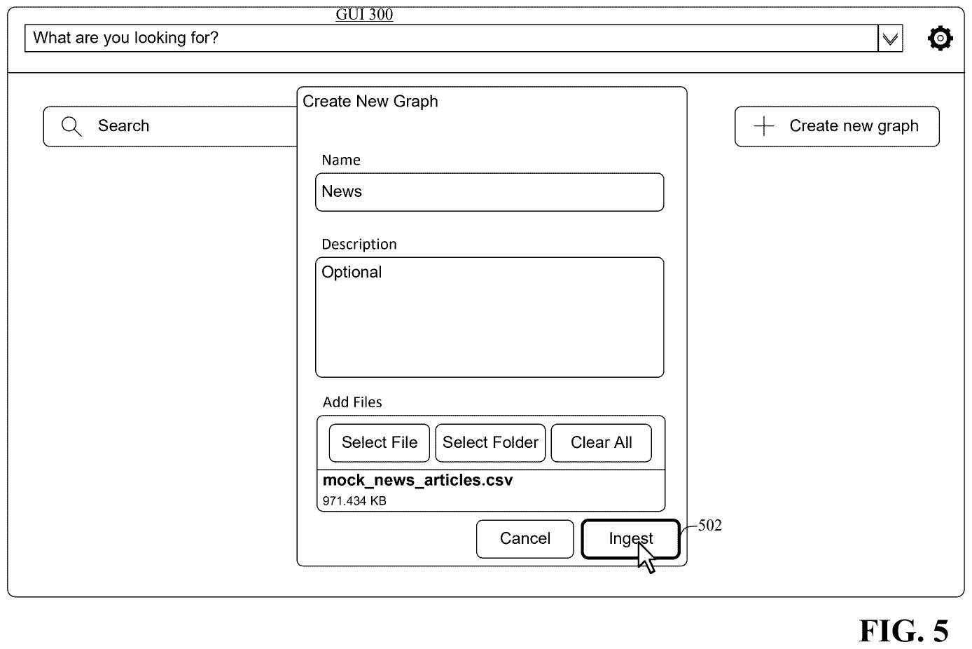

FIG. 5 shows the user selecting information to create the new graph. Assume for the purposes of example that the user selects a file entitled “mock_news_articles.csv” and decides to name the graph “News.” The user can then select the ingest button to initiate the process as indicated at 502.

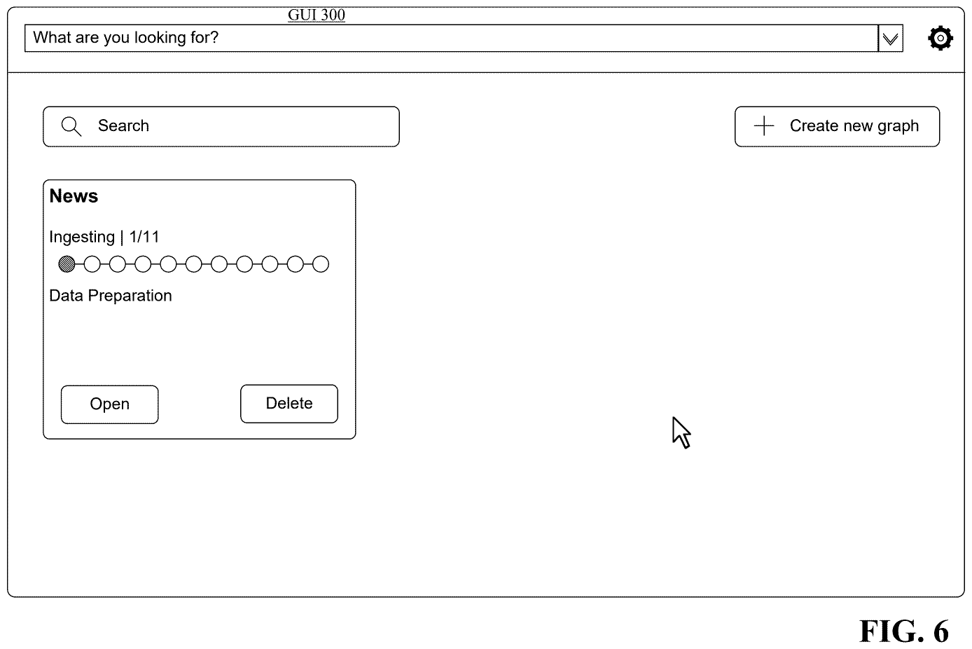

FIG. 6 illustrates the beginning of the ingestion process where the selected file is ingested by a LazyGraphRAG tool that is operating in the background and generating the GUI 300.

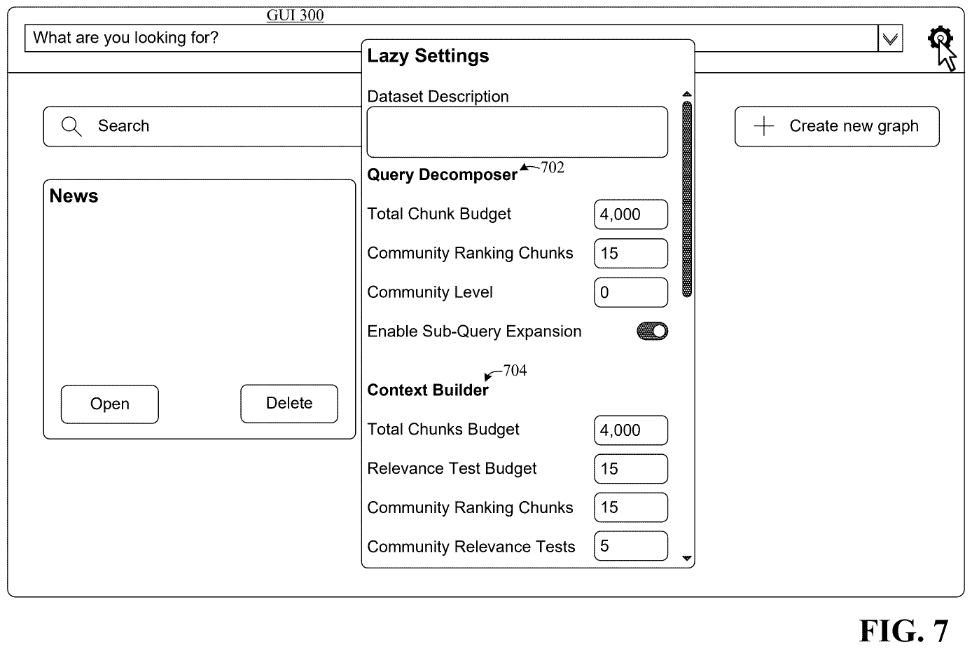

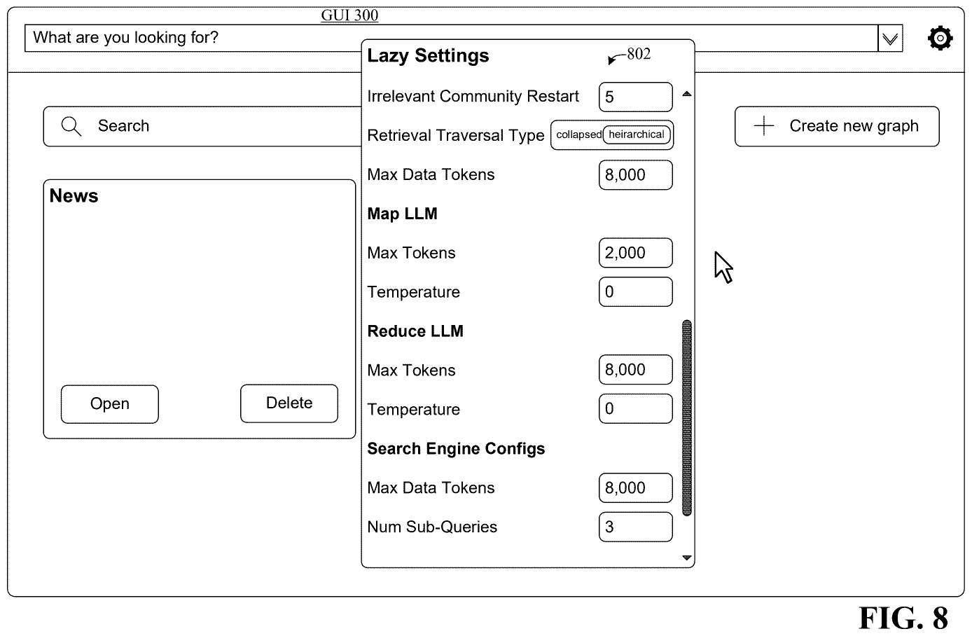

FIGS. 7 and 8 collectively show the user viewing the lazy settings menu, which lists various parameters by which the dataset can be processed. In this example, FIG. 7 shows the parameters relating to query decomposition parameters 702 and context builder parameters 704. The user can change these parameters to adapt the graph creation to better suit their needs. FIG. 8 shows parameters relating to resource usage as indicated at 802.

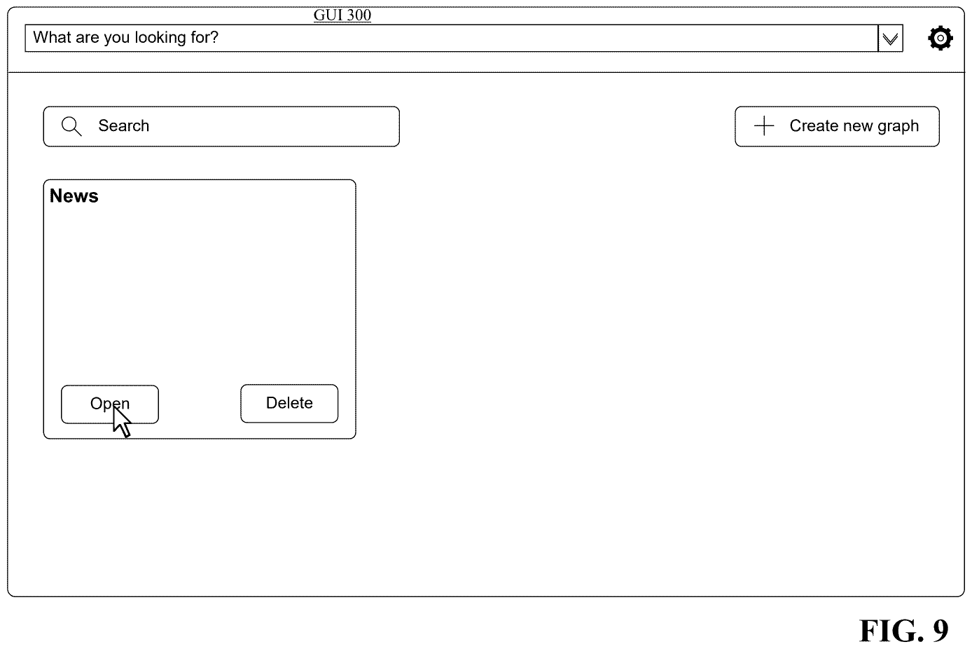

FIG. 9 shows the user choosing to open the newly created graph now that the ingestion process has been completed.

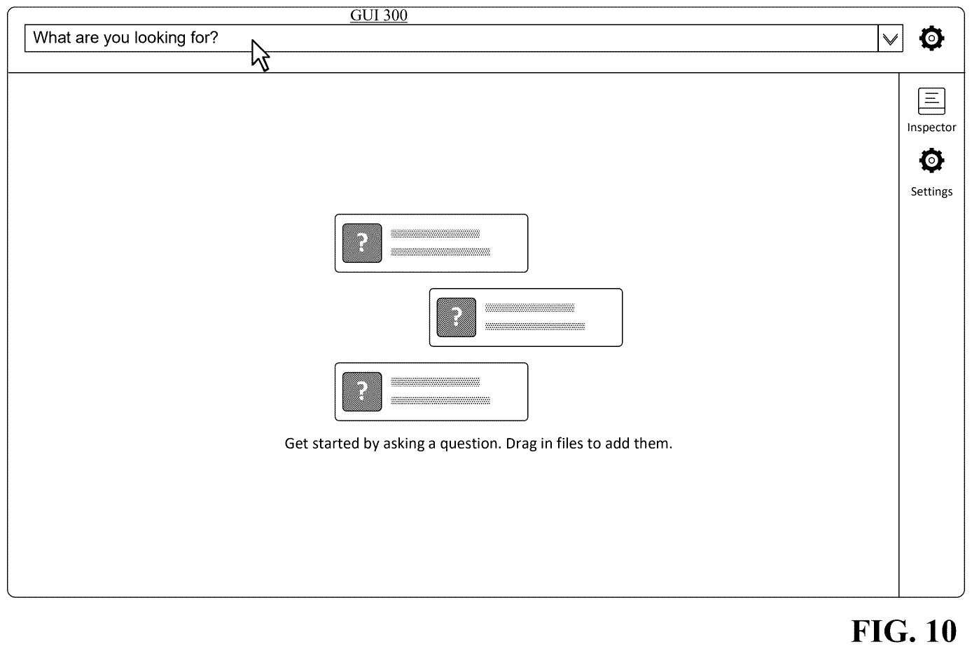

FIGS. 10-12 illustrate the user selecting the search bar at the top of the GUI and inputting the query, “What are the main political events in the data?” as indicated at 1202.

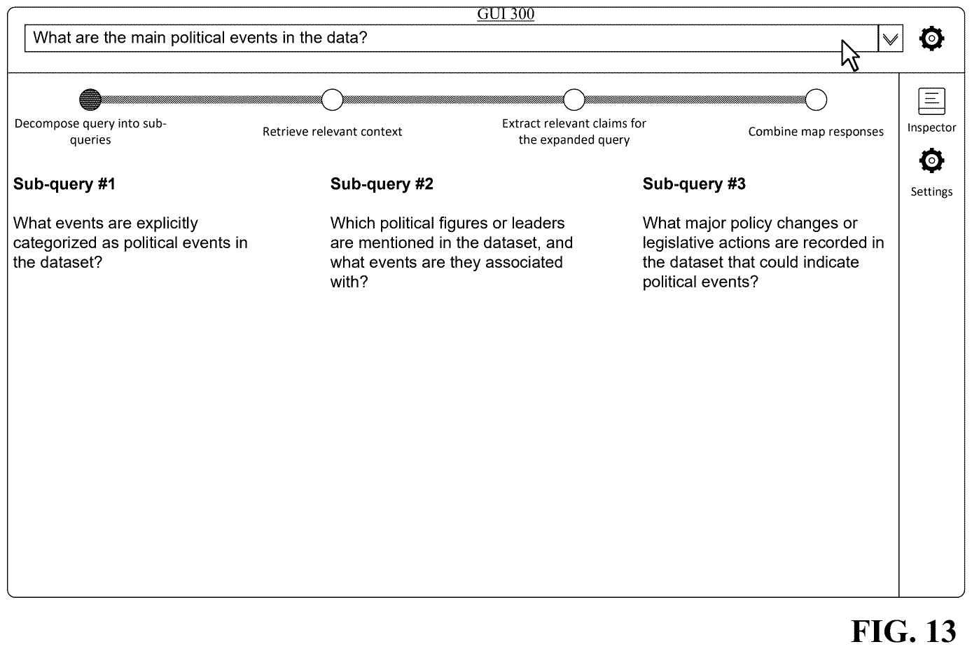

FIG. 13 shows the LazyGraphRAG GUI beginning to decompose the user query into sub-queries #1-3.

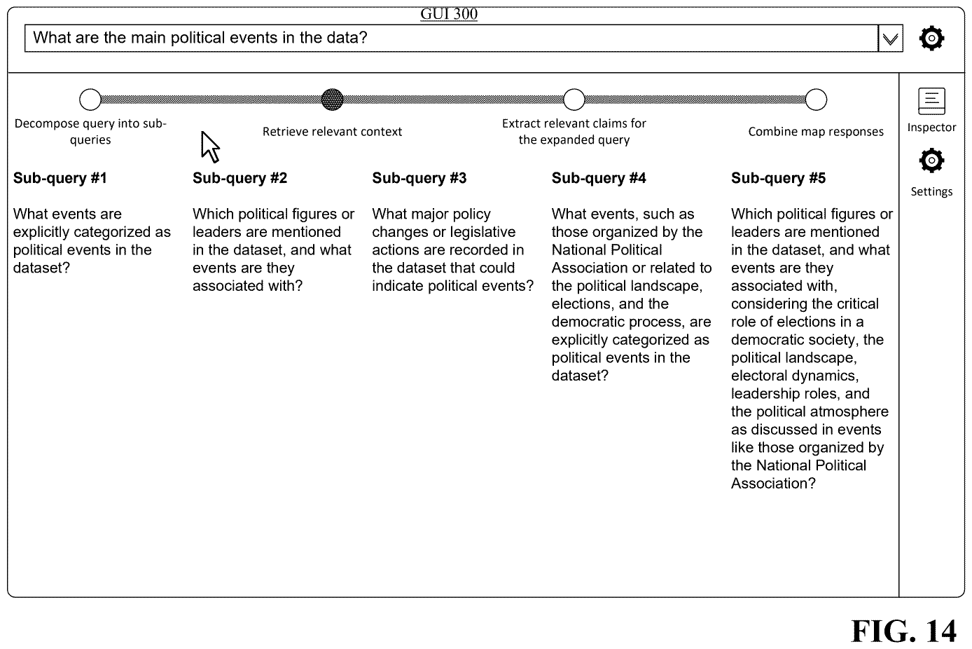

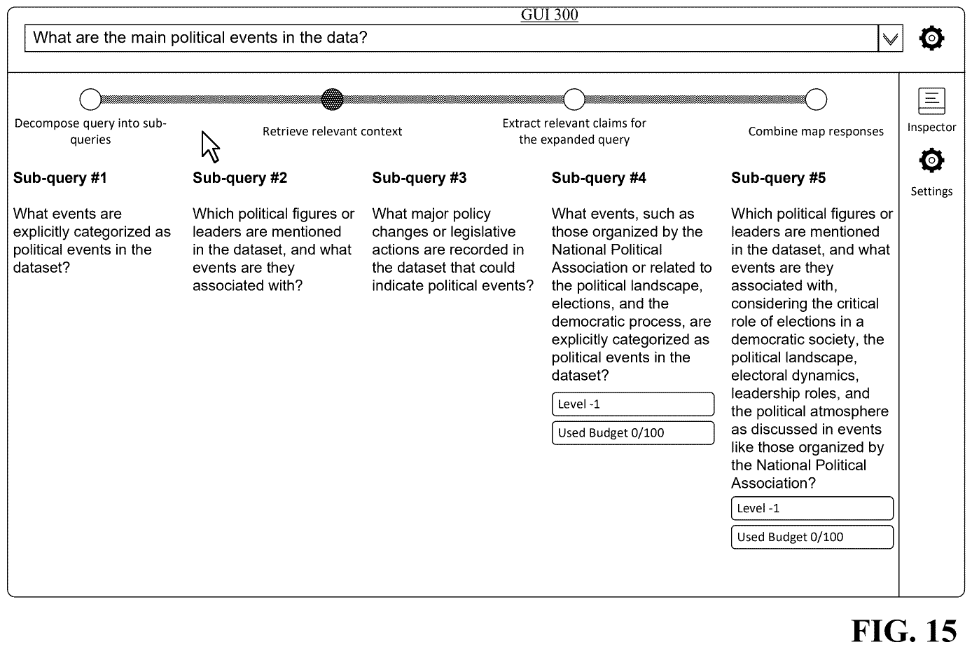

FIGS. 14 and 15 collectively show the decomposition of the queries into sub-queries, as well as moving on to the process of retrieving relevant context. This is illustrated in FIG. 14 by sub-queries #4 and #5 having more detailed and relevant context when compared to the first sub-queries. FIG. 15 then shows the GUI 300 listing more information, such as the Level and Used Chunk Budget of sub-queries #4 and #5. Note that the number of sub-queries and the amount of content in the sub-queries is limited on the drawing page and can be different in other example configurations.

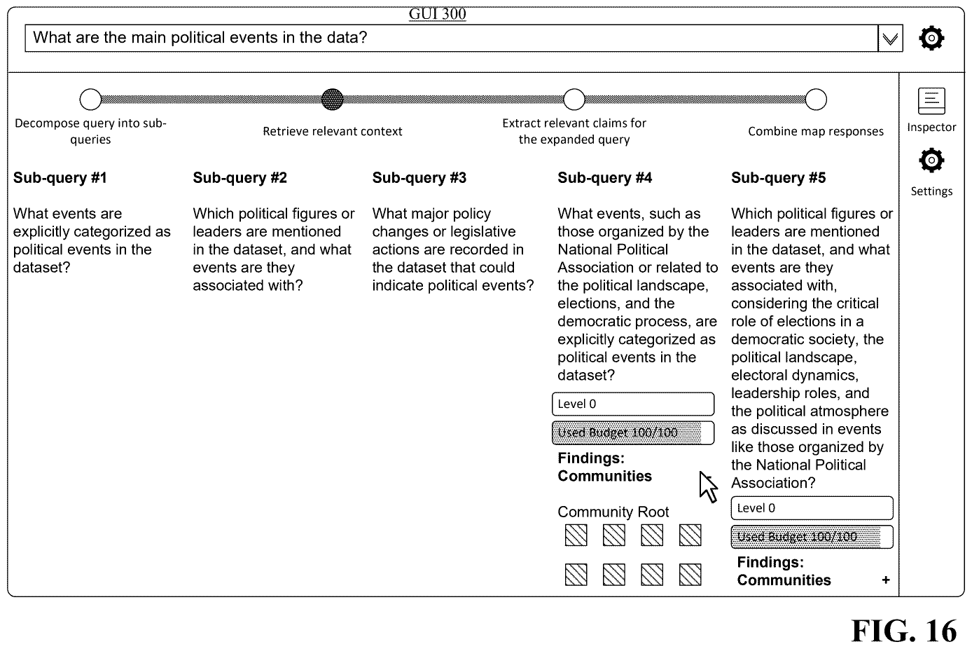

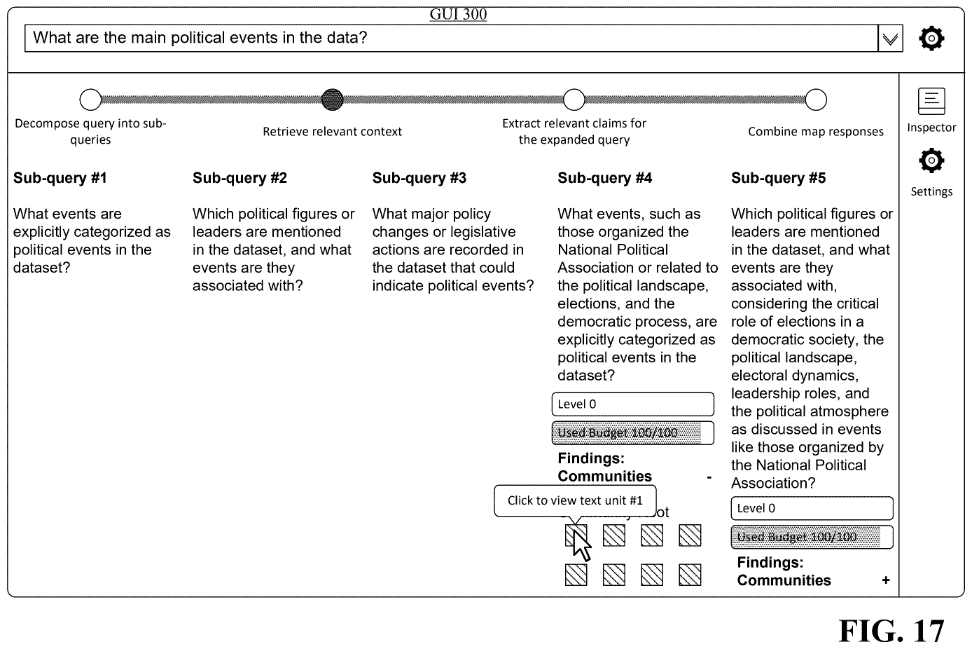

FIG. 16 then shows the user selecting the Communities dropdown menu corresponding to sub-query #4, revealing a list of text units in the Community Root. FIG. 17 then shows the user choosing to open text unit #1by selecting the icon.

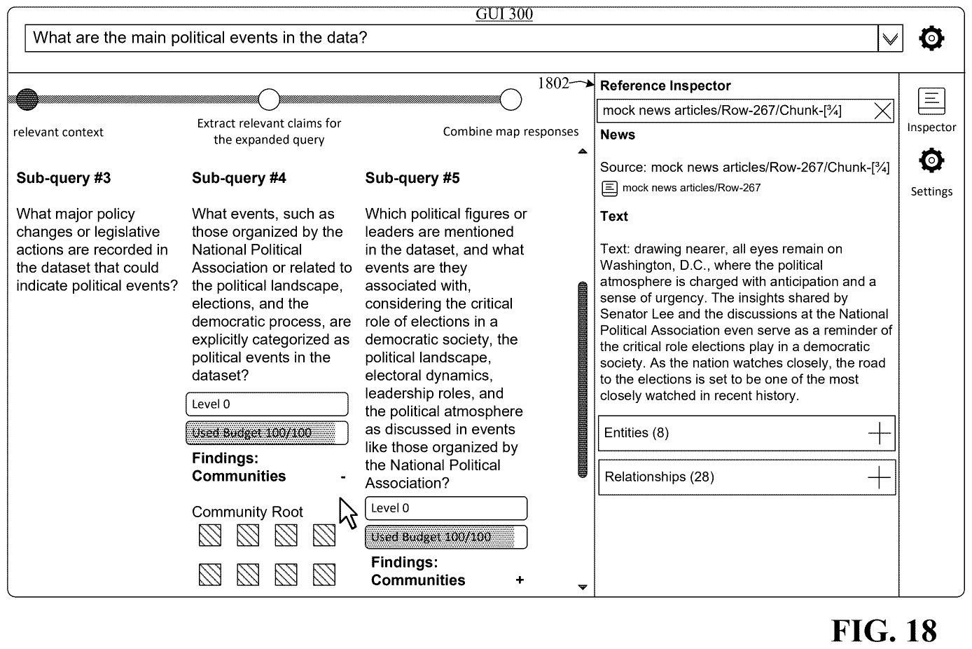

FIG. 18 shows the GUI opening a new Reference Inspector window 1802, which shows text pertaining to sub-query #4. The window also lists the source from which the text is extracted.

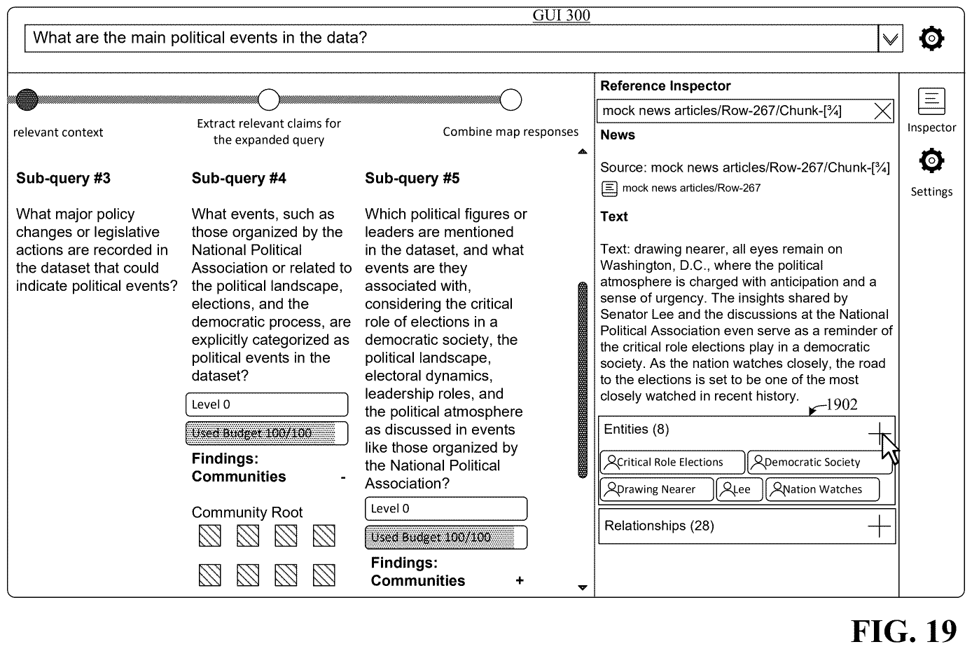

FIG. 19 shows the user opening the Entities dropdown menu 1902, which lists relevant people, organizations, concepts, etc., pertaining to the displayed text chunk.

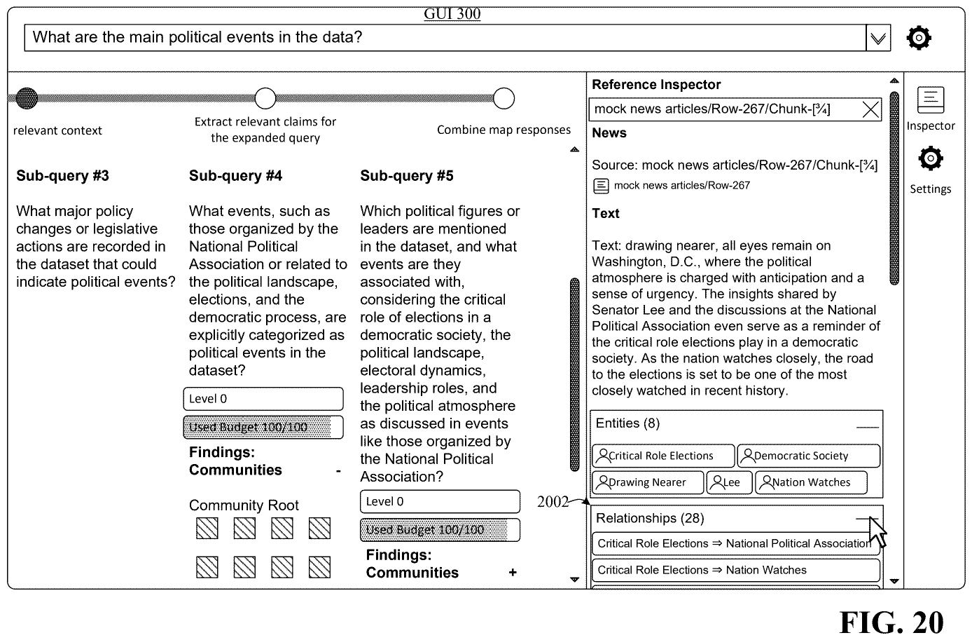

Similarly, FIG. 20 shows the user opening the Relationships dropdown menu 2002, which reveals connections or relationships between entities that are relevant to the text.

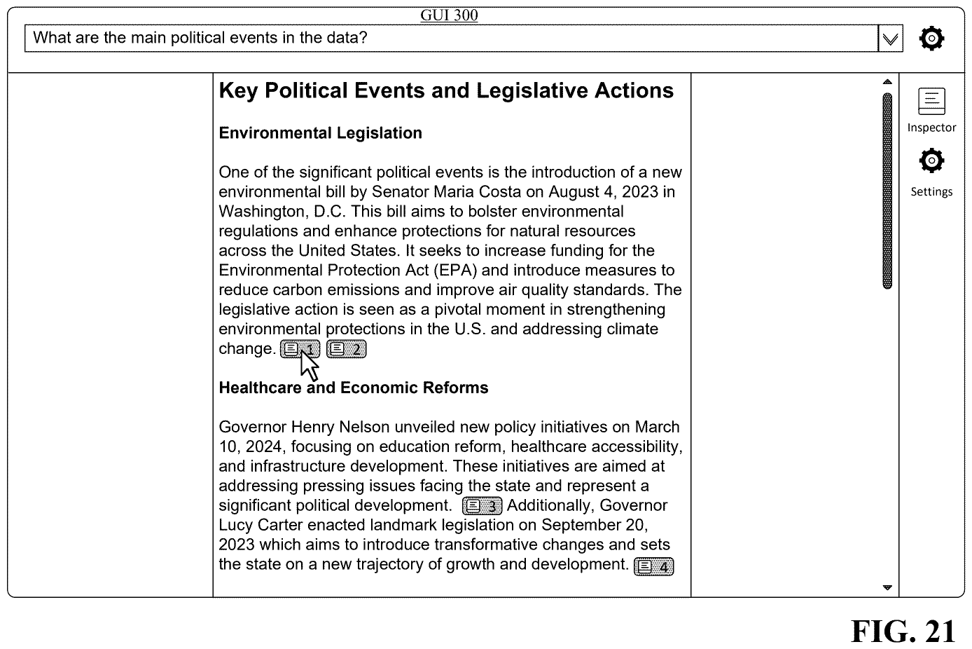

FIG. 21 shows the resulting text compiled from the file provided by the user, based on the previously set parameters. As shown in the figure, the text is considerably more detailed and provides a more comprehensive answer to the user's original query. In this example, the user is also choosing to open the text chunk #1 under the “Environmental Legislation” section of the article.

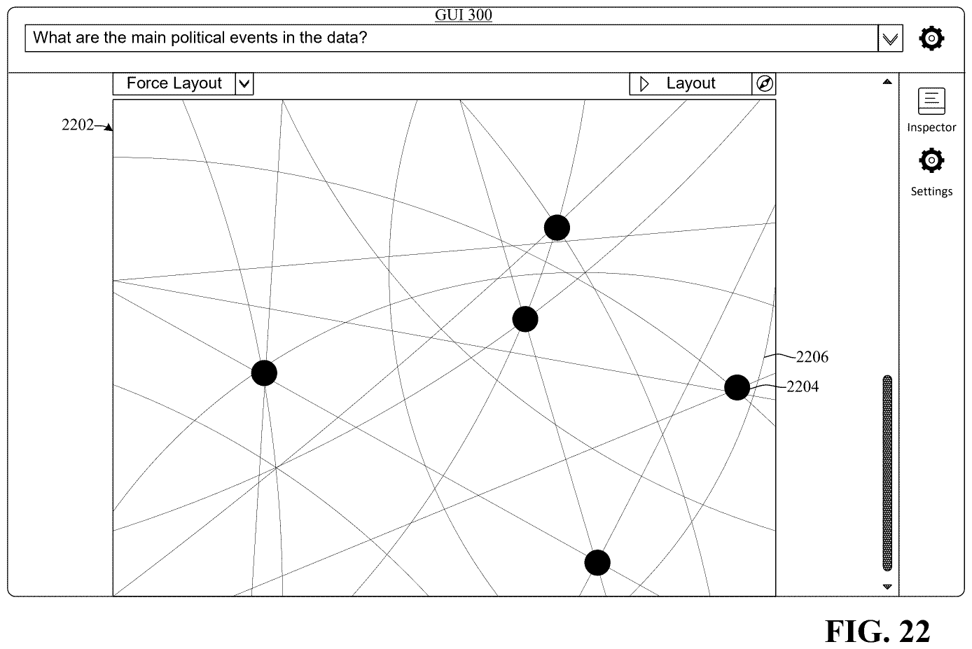

FIG. 22 shows the user scrolling down the window from the news article to view a graph 2202 depicting nodes 2204 and connections 2206. Note that only a small portion of the graph is shown. In many scenarios the graph may have thousands of nodes and connections. The nodes represent various data points that the LazyGraphRAG process deemed relevant to the user's query. These nodes can include entities such as, “Environmental Protection Act” or “Infrastructure Development”, which are both concepts listed in the resulting news article. The lines between these nodes are the connections or relationships between the entities.

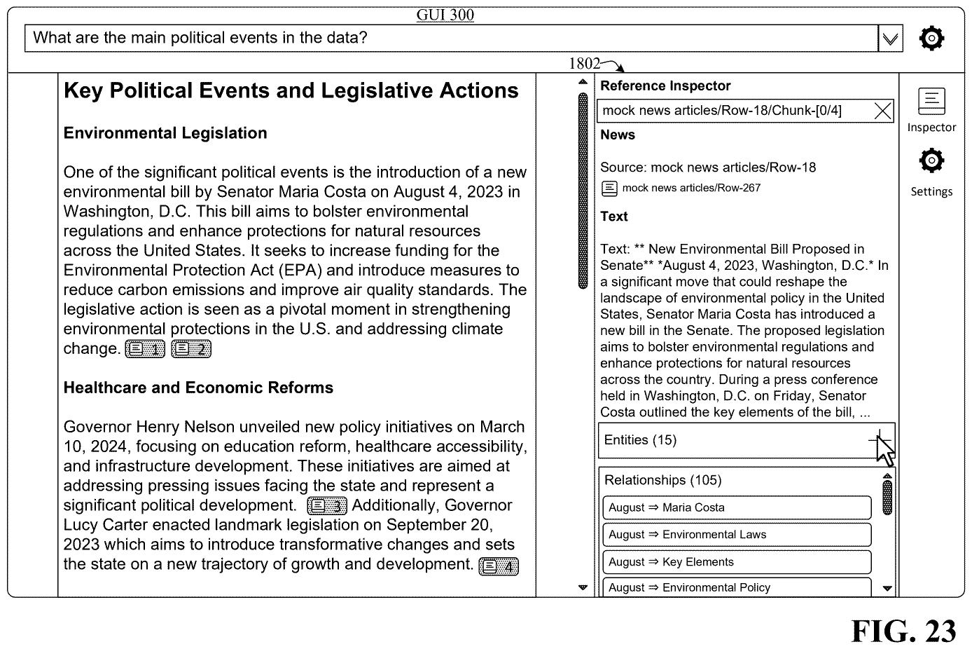

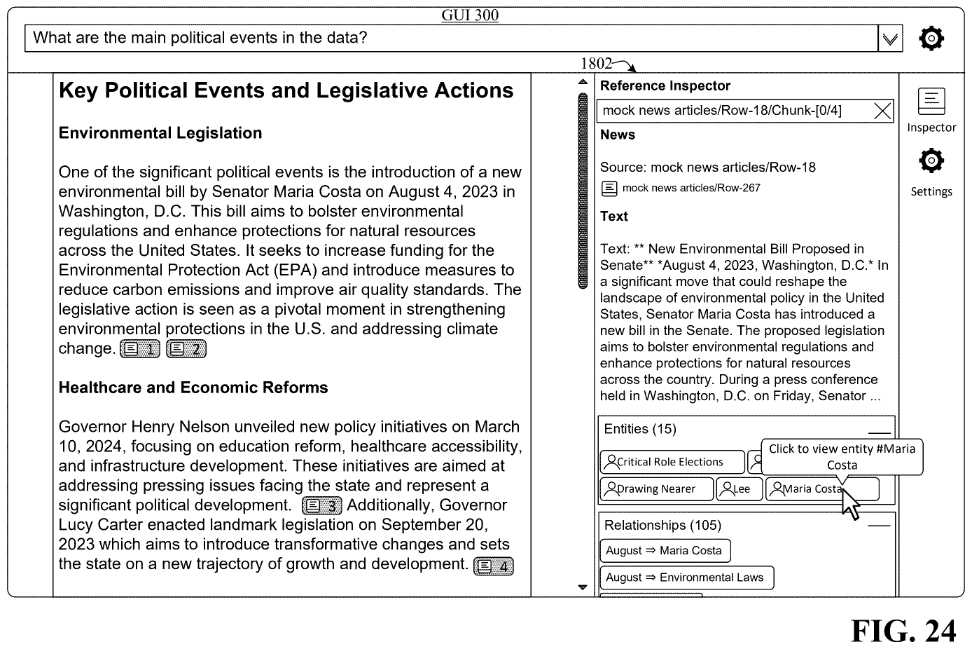

FIG. 23 shows the Reference Inspector window 1802 open once again after the user selected text chunk #1 (as shown in FIG. 21). The Reference Inspector window then lists the relevant information used to generate some of the text shown in the article. The user can then choose to expand the dropdown menu to view the listing of entities. FIG. 24 then shows the user hovering over and ultimately deciding to view the entity #Maria Costa.

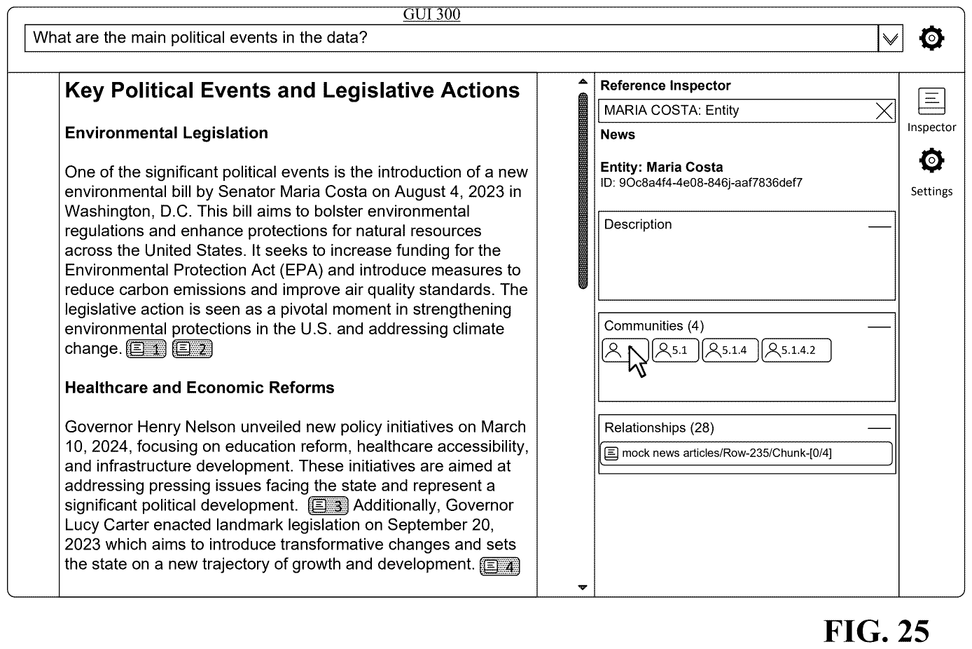

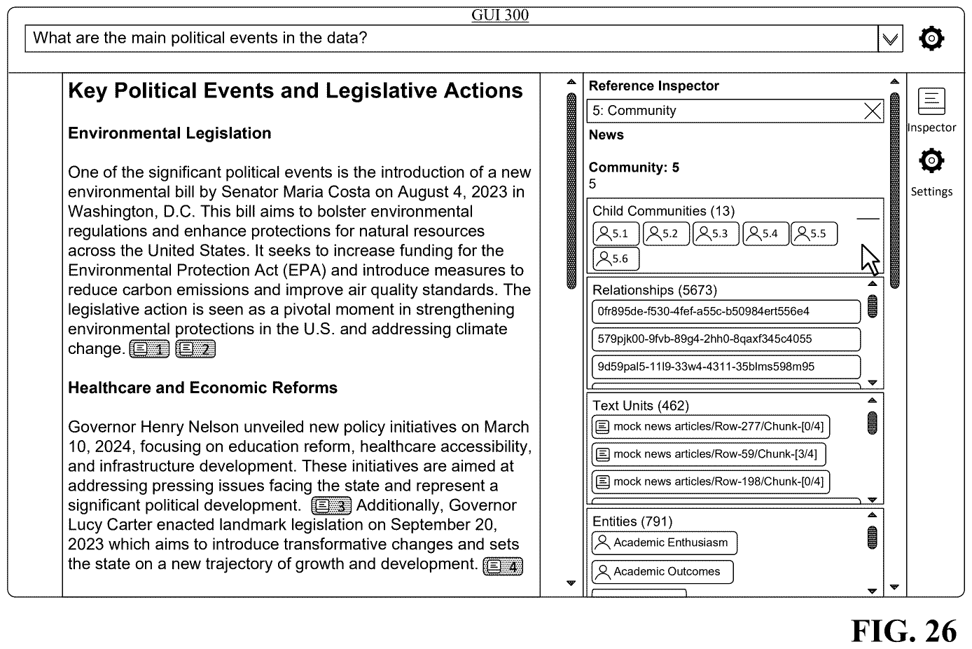

FIG. 25 shows the Reference Inspector window 1802 once again, but the information pertaining to text chunk #1 is replaced with details related to the entity labeled “Maria Costa”. The user then chooses to explore further into the information by opening the community #5 by selecting the icon. FIG. 26 subsequently shows the user viewing the details contained in community #5, including child communities, relationships, text units, and entities.

The description above relative to FIGS. 3-26 provides an example of how the present LazyGraphRAG concepts allow a user to explore their private dataset to obtain information that is meaningful to them while incurring minimal resource usage. Thus, the present concepts provide equal or better performance than existing techniques which greatly reduces resource usage. Further, the resource use is concentrated at latter stages in a manner dictated by the user's choices.

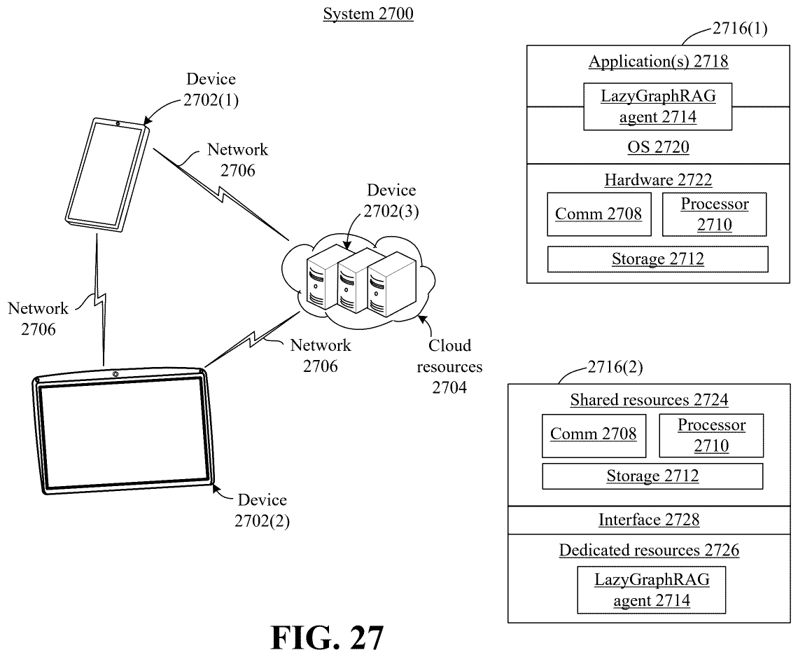

FIG. 27 shows an example LazyGraphRAG system 2700. System 2700 can include computing devices 2702. In the illustrated configuration, computing device 2702(1) is manifest as a smartphone, computing device 2702(2) is manifest as a tablet type device, and computing device 2702(3) is manifest as a server type computing device, such as may be found in a datacenter such as a cloud resource 2704. Computing devices 2702 can be coupled via one or more networks 2706 that are represented by lightning bolts. In some cases, some of the computing devices 2702 can function as edge devices between other computing devices.

Computing devices 2702 can include a communication component 2708, a processor 2710, storage resources (e.g., storage) 2712, and/or LazyGraphRAG tool or agent 2714. The LazyGraphRAG agent 2714 can be implemented as an application, framework, and/or service. The LazyGraphRAG agent 2714 can be implemented locally (e.g., on a user's device), on an edge device, and/or remotely, such as in the cloud. The LazyGraphRAG agent 2714 interacts with generative models. The generative models may be on the same device as the LazyGraphRAG agent 2714 or a different device. For example, the generative models can be implemented locally (e.g., on a user's device), on an edge device, and/or remotely, such as in the cloud.

LazyGraphRAG agent 2714 can access a private dataset associated with a user. The LazyGraphRAG agent 2714 can receive a user query relating to the private dataset. The LazyGraphRAG agent 2714 can embed the user query to generate query embeddings. The LazyGraphRAG agent 2714 can compare the query embeddings against embeddings of chunks of the private documents to generate ranked chunks. The LazyGraphRAG agent 2714 can obtain a comparison of the ranked chunks to community chunks relating to the private documents to produce ranked communities to the user query.

The LazyGraphRAG agent 2714 can generate graphical user interfaces (GUIs) for the user relating to the private dataset. Examples are described above relative to FIGS. 3-26. The GUIs can be configured to present information to the user and/or receive information from the user. The LazyGraphRAG agent 2714 can leverage generative models during the process and receive a final answer to the user query. The final answer can be presented via the GUI. The final answer is both highly relevant to the user query and obtained with less resources than previous techniques.

FIG. 27 shows two device configurations 2716 that can be employed by computing devices 2702. Individual computing devices 2702 can employ either of configurations 2716(1) or 2716(2), or an alternate configuration. (Due to space constraints on the drawing page, one instance of each configuration is illustrated). Briefly, device configuration 2716(1) represents an operating system (OS) centric configuration. Device configuration 2716(2) represents a system on a chip (SOC) configuration. Device configuration 2716(1) is organized into one or more applications 2718, operating system 2720, and hardware 2722. Device configuration 2716(2) is organized into shared resources 2724, dedicated resources 2726, and an interface 2728 therebetween.

In configuration 2716(1), the LazyGraphRAG agent 2714 can be manifest as part of the operating system 2720. Alternatively, the LazyGraphRAG agent 2714 can be manifest as part of the applications 2718 that operate in conjunction with the operating system 2720 and/or processor 2710. In configuration 2716(2), the LazyGraphRAG agent 2714 can be manifest as part of the processor 2710 or a dedicated resource 2726 that operates cooperatively with the processor 2710.

In some configurations, each of computing devices 2702 can have an instance of the LazyGraphRAG agent 2714. However, the functionalities that can be performed by the LazyGraphRAG agent 2714 may be the same or they may be different from one another when comparing computing devices. For instance, in some cases, each LazyGraphRAG agent 2714 can be robust and provide all of the functionality described above and below (e.g., a device-centric implementation).

In other cases, some devices can employ a less robust instance of the LazyGraphRAG agent 2714 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 2716(2) can be thought of as a system on a chip (SOC) type design. In such a case, functionality provided by the device can be integrated on a single SOC or multiple coupled SOCs. One or more processors 2710 can be configured to coordinate with shared resources 2724, such as storage 2712, etc., and/or one or more dedicated resources 2726, such as hardware blocks configured to perform certain specific functionality. Thus, the term “processor” as used herein can also refer to central processing units (CPUs), graphical processing units (GPUs), neural processing units (NPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “language model” refers to any type of automated agent that communicates via natural language. For instance, a language model can be implemented as a neural network, e.g., a decoder-based generative language model such as ChatGPT, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

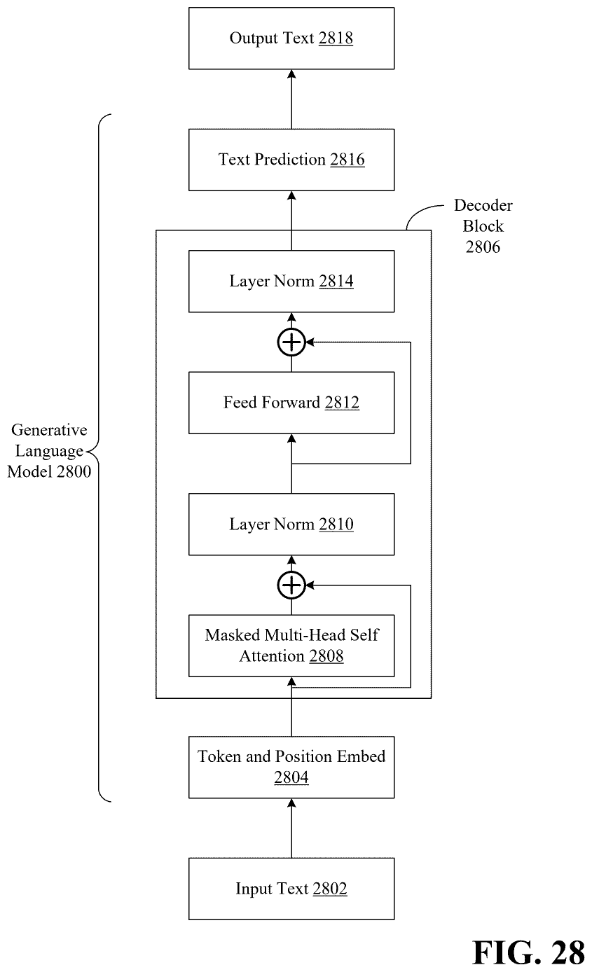

FIG. 28 illustrates an example generative model, such as generative language model 2800 that can be employed using the disclosed implementations. Generative language model 2800 is an example of a machine learning model that can be used to perform one or more natural language processing tasks that involve generating text, as discussed more below. For the purposes of this document, the term “natural language” means language that is normally used by human beings for writing or conversation.

Generative language model 2800 can receive input text 2802, e.g., a prompt from a user. For instance, the input text can include words, sentences, phrases, or other representations of language. The input text can be broken into tokens and mapped to token and position embeddings 2804 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 2804 are processed in one or more decoder blocks 2806. Each decoder block implements masked multi-head self-attention 2808, which is a mechanism relating different positions of tokens within the input text to compute the similarities between those tokens. Each token embedding is represented as a weighted sum of other tokens in the input text. Attention is only applied for already-decoded values, and future values are masked. Layer normalization 2810 normalizes features to mean values of 0 and variance to 1, resulting in smooth gradients. Feed forward layer 2812 transforms these features into a representation suitable for the next iteration of decoding, after which another layer normalization 2814 is applied. Multiple instances of decoder blocks can operate sequentially on input text, with each subsequent decoder block operating on the output of a preceding decoder block. After the final decoding block, text prediction layer 2816 can predict the next word in the sequence, which is output as output text 2818 in response to the input text 2802 and also fed back into the language model. The output text can be a newly-generated response to the prompt provided as input text to the generative language model.

### EXAMPLE METHODS

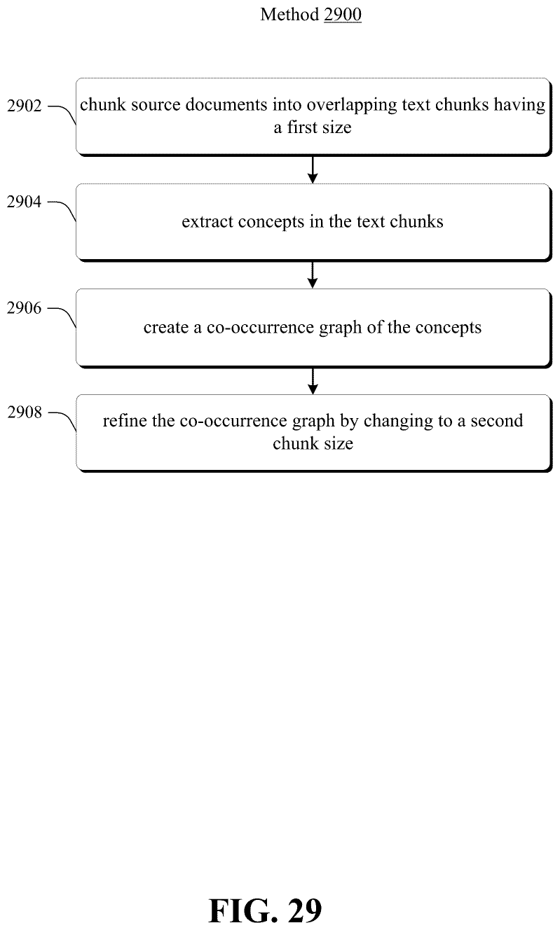

FIG. 29 shows a flowchart or method 2900 associated with LazyGraphRAG concepts.

Block 2902 can chunk source documents into overlapping text chunks having a first size.

Block 2904 can extract concepts in the text chunks.

Block 2906 can create a co-occurrence graph of the concepts.

Block 2908 can refine the co-occurrence graph by changing to a second chunk size.

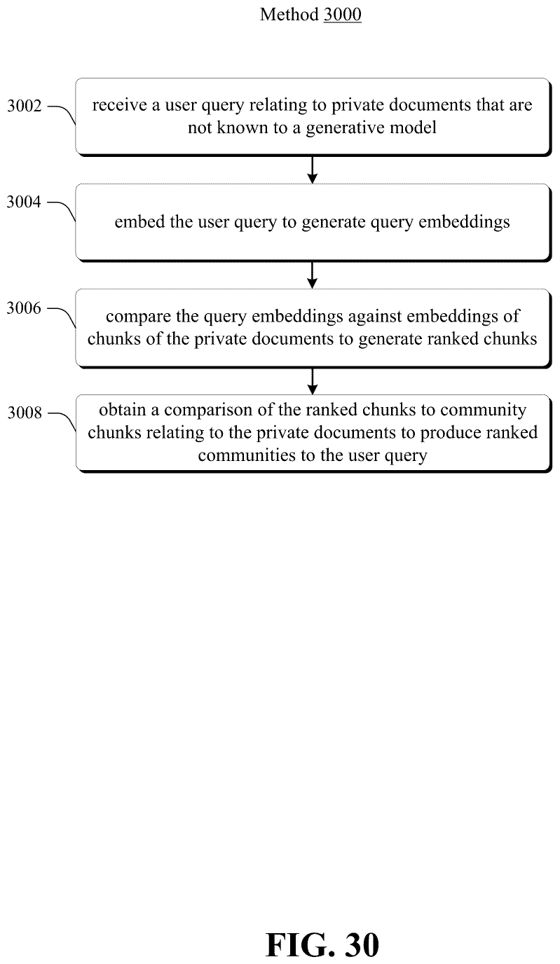

FIG. 30 shows a flowchart or method 3000 associated with LazyGraphRAG concepts.

Block 3002 can receive a user query relating to private documents that are not known to a generative model.

Block 3004 can embed the user query to generate query embeddings.

Block 3006 can compare the query embeddings against embeddings of chunks of the private documents to generate ranked chunks.

Block 3008 can obtain a comparison of the ranked chunks to community chunks relating to the private documents to produce ranked communities to the user query.

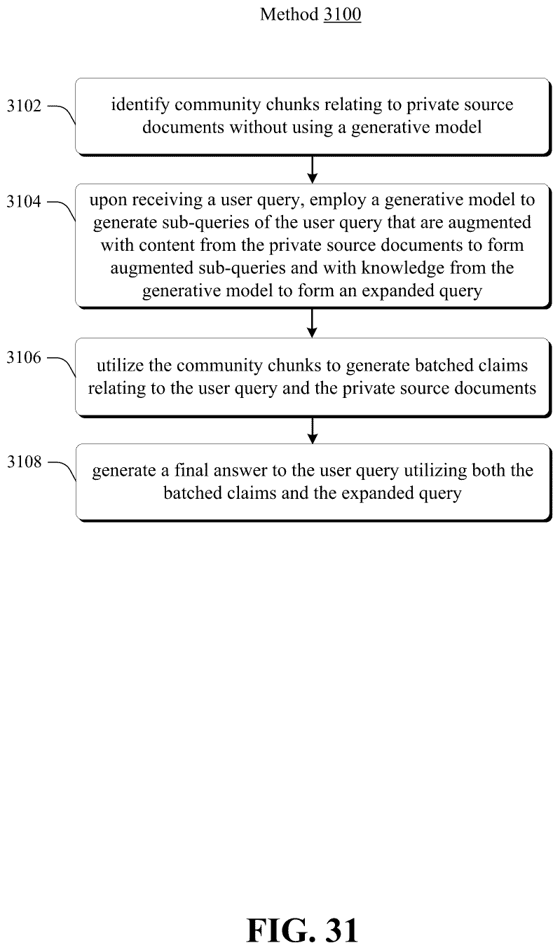

FIG. 31 shows a flowchart or method 3100 associated with LazyGraphRAG concepts.

Block 3102 can identify community chunks relating to private source documents without using a generative model.

Block 3104 can upon receiving a user query, employ a generative model to generate sub-queries of the user query that are augmented with content from the private source documents to form augmented sub-queries and with knowledge from the generative model to form an expanded query.

Block 3106 can utilize the community chunks to generate batched claims relating to the user query and the private source documents.

Block 3108 can generate a final answer to the user query utilizing both the batched claims and the expanded query.

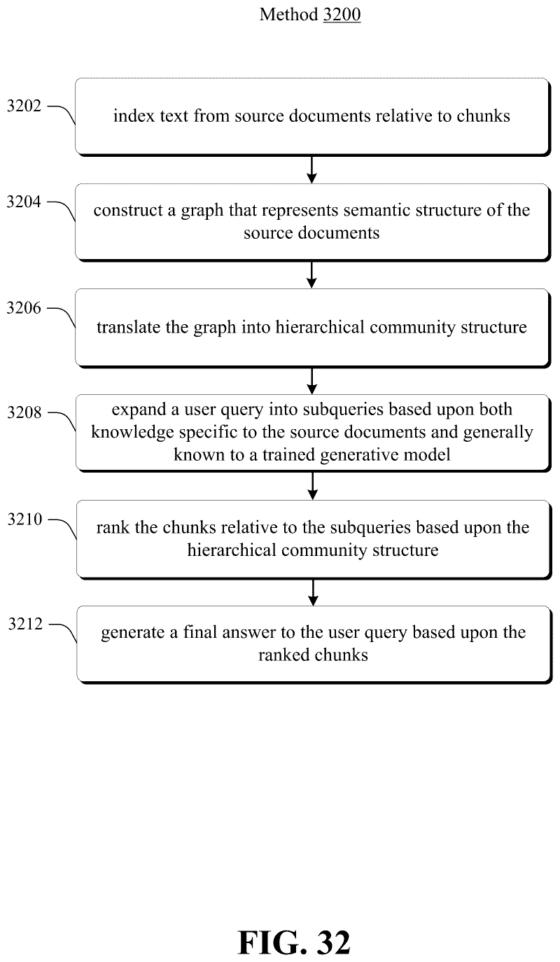

FIG. 32 shows a flowchart or method 3200 associated with LazyGraphRAG concepts.

Block 3202 can index text from source documents relative to chunks.

Block 3204 can construct a graph that represents semantic structure of the source documents.

Block 3206 can translate the graph into hierarchical community structure.

Block 3208 can expand a user query into sub-queries based upon both knowledge specific to the source documents and generally known to a trained generative model.

Block 3210 can rank the chunks relative to the sub-queries based upon the hierarchical community structure.

Block 3212 can generate a final answer to the user query based upon the ranked chunks.

The order in which these methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage medium/media as a set of instructions such that execution by a processor of a computing device causes the computing device to perform the method.

Various examples are described above. Additional examples are described below. One example includes a device-implemented method comprising chunking source documents into overlapping text chunks having a first size, extracting concepts in the text chunks, creating a co-occurrence graph of the concepts, and refining the co-occurrence graph by changing to a second chunk size.

Another example can include any of the above and/or below examples where the refining changes a modularity of the co-occurrence graph.

Another example can include any of the above and/or below examples where the concepts comprise filtered noun phrases, and wherein the extracting is accomplished with natural language processing.

Another example can include any of the above and/or below examples where the method further comprises inferring concept communities from the refined co-occurrence graph.

Another example can include any of the above and/or below examples where the method further comprises assigning individual text chunks to individual concept communities.

Another example can include any of the above and/or below examples where the method further comprises subsequently receiving additional source documents.

Another example can include any of the above and/or below examples where the method further comprises chunking the additional source documents into overlapping additional text chunks.

Another example can include any of the above and/or below examples where the method further comprises adding the concepts from the additional text chunks to the co-occurrence graph of the concepts.

Another example can include any of the above and/or below examples where the method further comprises embedding text from the text chunks and matching the embedding to a user input query.

Another example can include any of the above and/or below examples where the matching comprises matching embedded text from the text chunks to embeddings of decomposed sub-queries of the user input query.

Another example can include a system comprising storage configured to store computer-readable instructions, and a processor configured to execute the computer-readable instructions to receive a user query relating to private documents that are not known to a generative model, embed the user query to generate query embeddings, compare the query embeddings against embeddings of chunks of the private documents to generate ranked chunks, and obtain a comparison of the ranked chunks to community chunks relating to the private documents to produce ranked communities to the user query.

Another example can include any of the above and/or below examples where obtaining a comparison comprises sending the ranked chunks and the community chunks to a generative model and obtaining the ranked communities from the generative model.

Another example can include any of the above and/or below examples where the community chunks relate to a community hierarchy, and wherein the comparing to the community chunks is performed at multiple levels of the hierarchy.

Another example can include any of the above and/or below examples where the processor is further configured to execute computer-readable instructions to aggregate the ranked chunks into a focused graph.

Another example can include any of the above and/or below examples where the system further comprises the processor is configured to infer focused communities from the focused graph, to allocate batched chunks from the focused communities, to map batched claims from the batched chunks, and to generate a final answer to the user query from the batched claims.

Another example can include a computer-readable storage medium storing instructions comprising identify community chunks relating to private source documents without using a generative model, upon receiving a user query, employ a generative model to generate sub-queries of the user query that are augmented with content from the private source documents to form augmented sub-queries and with knowledge from the generative model to form an expanded query, utilize the community chunks to generate batched claims relating to the user query and the private source documents, and generate a final answer to the user query utilizing both the batched claims and the expanded query.

Another example can include any of the above and/or below examples where the identifying community chunks comprises dividing the private source documents into text chunks, adding input text metadata to the text chunks, embedding the text chunks, extracting noun-phrases from the text chunks without using a generative model, building a concept co-occurrence graph using text chunk co-occurrences, detecting communities in the co-occurrence graph, ranking the communities linked to each text chunk based on numbers of distinct concepts in both an individual text chunk and an individual community, assigning chunks as belonging to top-ranked communities that have highest concept overlap.

Another example can include any of the above and/or below examples where utilizing the community chunks to generate batched claims relating to the user query and the private source documents comprises ranking text chunks based on semantic similarity with the user query, ranking communities based on mean ranking of a number of high ranking text chunks, visiting communities in rank order, testing relevance of untested text chunks, and discarding communities that do not yield relevant text chunks.

Another example can include any of the above and/or below examples where generating a final answer to the user query utilizing both the batched claims and the expanded query comprises using highly ranked chunks to generate a response to the user query via a map-reduce process that comprises batching relevant chunks and using generative model text completions to answer the sub-queries independently and in parallel and passing the sub-query answers to a final generative model to generate the final answer or a map-refine process that comprises batching relevant chunks and using generative model text completions to answer the user query sequentially based on both a current batch of text chunks and the sub-query answers.

Another example can include any of the above and/or below examples where identifying community chunks comprises identifying community chunks of a first size, generating a concept graph from the community chunks of the first size, generating community chunks of a second different size, and refining the concept graph with the community chunks of the second different size.

Another example can include a device-implemented method comprising indexing text from source documents relative to chunks, constructing a graph that represents semantic structure of the source documents, translating the graph into hierarchical community structure, expanding a user query into sub-queries based upon both knowledge specific to the source documents and generally known to a trained generative model, ranking the chunks relative to the sub-queries based upon the hierarchical community structure, and generating a final answer to the user query based upon the ranked chunks.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A device-implemented method comprising:
chunking source documents into overlapping text chunks having a first size;
extracting concepts in the text chunks;
creating a co-occurrence graph of the concepts; and,
refining the co-occurrence graph by changing to a second chunk size.

2. The method of claim 1, wherein the refining changes a modularity of the co-occurrence graph.

3. The method of claim 1, wherein the concepts comprise filtered noun phrases, and wherein the extracting is accomplished with natural language processing.

4. The method of claim 1, further comprising inferring concept communities from the refined co-occurrence graph.

5. The method of claim 4, further comprising assigning individual text chunks to individual concept communities.

6. The method of claim 5, further comprising subsequently receiving additional source documents.

7. The method of claim 6, further comprising chunking the additional source documents into overlapping additional text chunk.

8. The method of claim 7, further comprising adding the concepts from the additional text chunks to the co-occurrence graph of the concepts.

9. The method of claim 1, further comprising embedding text from the text chunks and matching the embedding to a user input query.

10. The method of claim 9, wherein the matching the embedding to embeddings of decomposed sub-queries of the user input query.

11. A system, comprising:
storage configured to store computer-readable instructions; and,
a processor configured to execute the computer-readable instructions to:
receive a user query relating to private documents that are not known to a generative model;
embed the user query to generate query embeddings;
compare the query embeddings against embeddings of chunks of the private documents to generate ranked chunks; and,
obtain a comparison of the ranked chunks to community chunks relating to the private documents to produce ranked communities to the user query.

12. The system of claim 11, wherein obtaining a comparison comprises sending the ranked chunks and the community chunks to a generative model and obtaining the ranked communities from the generative model.

13. The system of claim 11, wherein the community chunks relate to a community hierarchy, and wherein the comparing to the community chunks is performed at multiple levels of the hierarchy.

14. The system of claim 11, wherein the processor is further configured to execute computer-readable instructions to aggregate the ranked chunks into a focused graph.

15. The system of claim 14, further comprising the processor is configured to infer focused communities from the focused graph, to allocate batched chunks from the focused communities, to map batched claims from the batched chunks, and to generate a final answer to the user query from the batched claims.

16. A computer-readable storage medium storing instructions comprising:
identify community chunks relating to private source documents without using a generative model;
upon receiving a user query, employ a generative model to generate sub-queries of the user query that are augmented with content from the private source documents to form augmented sub-queries and with knowledge from the generative model to form an expanded query;
utilize the community chunks to generate batched claims relating to the user query and the private source documents; and,
generate a final answer to the user query utilizing both the batched claims and the expanded query.

17. The computer-readable storage medium of claim 16, wherein the identifying community chunks comprises dividing the private source documents into text chunks, adding input text metadata to the text chunks, embedding the text chunks, extracting noun-phrases from the text chunks without using a generative model, building a concept co-occurrence graph using text chunk co-occurrences, detecting communities in the co-occurrence graph, ranking the communities linked to each text chunk based on numbers of distinct concepts in both an individual text chunk and an individual community, assigning chunks as belonging to top-ranked communities that have highest concept overlap.

18. The computer-readable storage medium of claim 17, wherein utilizing the community chunks to generate batched claims relating to the user query and the private source documents comprises ranking text chunks based on semantic similarity with the user query, ranking communities based on mean ranking of a number of high ranking text chunks, visiting communities in rank order, testing relevance of untested text chunks, and discarding communities that do not yield relevant text chunks.

19. The computer-readable storage medium of claim 17, wherein generating a final answer to the user query utilizing both the batched claims and the expanded query comprises using highly ranked chunks to generate a response to the user query via a map-reduce process that comprises batching relevant chunks and using generative model text completions to answer the sub-queries independently and in parallel and passing the sub-query answers to a final generative model to generate the final answer or a map-refine process that comprises batching relevant chunks and using generative model text completions to answer the user query sequentially based on both a current batch of text chunks and the sub-query answers.

20. The computer-readable storage medium of claim 16, wherein identifying community chunks comprises identifying community chunks of a first size, generating a concept graph from the community chunks of the first size, generating community chunks of a second different size, and refining the concept graph with the community chunks of the second different size.
